(19) United States
(12) Patent Application Publication
(10) Pub. No.: US 2026/0234768 A1
(43) Pub. Date: Aug. 13, 2026

(54) HOT-STAMPING FORMED BODY

(71) Applicant: NIPPON STEEL CORPORATION, Tokyo (JP)

(72) Inventors: Shingo FUJINAKA, Tokyo (JP); Hitomi NISHIBATA, Tokyo (JP)

(73) Assignee: NIPPON STEEL CORPORATION, Tokyo (JP)

(21) Appl. No.: 19/471,045

(22) PCT Filed: Apr. 11, 2024
(86) PCT No.: PCT/JP2024/014707

§ 371 Date: Sep. 30, 2025

(30) Foreign Application Priority Data
Apr. 13, 2023 (JP) 2023-065610

(51) Int. Cl. C22C 38/14; B32B 15/01; C21D 1/84; C21D 6/00; C21D 8/04; C21D 9/48; C22C 38/00; C22C 38/02; C22C 38/04; C22C 38/06; C22C 38/08; C22C 38/10; C22C 38/12; C22C 38/16; C22C 38/22; C22C 38/28; C22C 38/32; C22C 38/60

(52) U.S. Cl. CPC C22C 38/14; B32B 15/011; C21D 1/84; C21D 6/001; C21D 6/002; C21D 6/005; C21D 6/007; C21D 6/008; C21D 8/0426; C21D 8/0436; C21D 8/0463; C21D 9/48; C22C 38/001; C22C 38/002; C22C 38/005; C22C 38/02; C22C 38/04; C22C 38/06; C22C 38/08; C22C 38/10; C22C 38/12; C22C 38/16; C22C 38/22; C22C 38/28; C22C 38/32; C22C 38/60; B32B 2250/02; B32B 2311/30; C21D 2211/001; C21D 2211/005; C21D 2211/008

(57) ABSTRACT

A hot-stamping formed body has a predetermined chemical composition, and when a range from a position at ⅛ of a thickness to a position at ⅜ of the thickness in a thickness direction from a surface is set as a ¼-depth position, a microstructure at the ¼-depth position includes, by area ratio, martensite: 80.0% or more and retained austenite: 0.0% or more and less than 5.0%, in the microstructure at the ¼-depth position, a number density of an iron-based carbide present in the martensite and having a circle equivalent diameter of more than 0.5 μm is less than 0.050 particles/μm², and an average distance between the iron-based carbide and another iron-based carbide nearest thereto is 3.0 μm or more, and in the microstructure at the ¼-depth position, a prior austenite grain size is 20.0 μm or less.

### TECHNICAL FIELD

The present invention relates to a hot-stamping formed body.

Priority is claimed on Japanese Patent Application No. 2023-065610, filed on Apr. 13, 2023, the content of which is incorporated herein by reference.

### BACKGROUND ART

In the field of steel sheets for a vehicle, in order to improve both fuel consumption and collision safety against the background of recent stringent environmental regulations and collision safety standards, the application of a steel sheet having high tensile strength (high-strength steel sheet) has expanded. However, the press formability of a steel sheet decreases with high-strengthening, which makes it difficult to produce a product having a complex shape.

Specifically, the ductility of the steel sheet decreases with high-strengthening, and there is a problem in that the steel sheet is fractured at a highly processed portion in a case where the steel sheet is processed into a complex shape. In addition, with high-strengthening of the steel sheet, residual stress after processing causes springback and wall curvature, which also causes a problem in that dimensional accuracy is deteriorated. Therefore, it is not easy to press-form a steel sheet having a high strength, particularly a tensile strength of 780 MPa or more, into a product having a complex shape. Roll forming rather than press forming makes it easier to process a high-strength steel sheet, but the application thereof is limited to components having a uniform cross section in a longitudinal direction thereof.

Therefore, in recent years, for example, as disclosed in Patent Documents 1 to 3, hot stamping has been adopted as a technology of press-forming a material that is difficult to form, such as a high-strength steel sheet. Hot stamping is a hot forming technology of heating a material to be subjected to forming and then forming the material.

In this technology, the material is formed after being heated. Therefore, the steel is soft during forming and has good formability. Therefore, even a high-strength steel sheet can be accurately formed into a complex shape. In addition, in hot stamping, since quenching is performed simultaneously with forming by a pressing die, the steel (steel member, hot-stamping formed body) after forming has a sufficient strength.

For example, Patent Document 1 discloses that it is possible to impart a tensile strength of 1,400 MPa or more to a steel member obtained by forming a steel sheet through hot stamping.

In recent years, countries around the world have set higher CO₂ reduction targets, and each vehicle manufacturer has progressed in reducing fuel consumption in consideration of collision safety. Not only gasoline vehicles but also electric vehicles that have been rapidly developed require, as their materials, higher strength materials to protect not only passengers but also batteries from collision and to cancel out the amount of increase in weight. For example, for a steel member used for vehicles and the like, steel is required which has excellent collision resistance characteristics and higher strength exceeding the strength generally used in Patent Document 1 described above or for a steel member (hot-stamping formed body) formed currently by hot stamping.

Regarding a high-strength steel having a tensile strength of 1.5 GPa or more, for example, Patent Document 2 discloses a press-formed article that has excellent toughness and a tensile strength of 1.8 GPa or more and is subjected to hot press forming. Patent Document 3 discloses steel that has an extremely high tensile strength of 2.0 GPa or more and further has good toughness and good ductility. Patent Document 4 discloses steel that has an extremely high tensile strength of 1.8 GPa or more and further has good toughness. Patent Document 5 discloses steel that has an extremely high tensile strength of 2.0 GPa or more and further has good toughness.

However, as a result of the studies by the present inventors, it has been found that, in Patent Documents 2 to 5, sufficient collision resistance characteristics (bending cracking resistance and crack propagation resistance characteristics during deformation by collision) may not be obtained to meet the increasing demands of recent years.

### CITATION LIST

### Patent Documents

Patent Document 1: Japanese Unexamined Patent Application, First Publication No. 2002-102980
Patent Document 2: Japanese Unexamined Patent Application, First Publication No. 2012-180594
Patent Document 3: Japanese Unexamined Patent Application, First Publication No. 2012-1802
Patent Document 4: PCT International Publication No. WO2015/182596
Patent Document 5: PCT International Publication No. WO2015/182591

### SUMMARY OF INVENTION

### Technical Problem

As described above, hot-stamping formed bodies having a tensile strength of 1.5 GPa (1,500 MPa) or more have been disclosed. However, in any case, there is room for improvement in collision resistance characteristics.

Therefore, an object of the present invention is to provide a hot-stamping formed body having high strength and excellent collision resistance characteristics.

### Solution to Problem

The present inventors conducted studies on improving collision resistance characteristics on the premise of a hot-stamping formed body in which a C content is increased to obtain a high strength.

As a result, they obtained the following findings.

(i) In a case where a high-strength (for example, a tensile strength of 1.5 GPa or more) hot-stamping formed body is obtained, a large amount of carbon (C) is contained to secure high strength as disclosed in Patent Documents 2 and 3. In this case, an undissolved carbide is likely to remain in the hot-stamping formed body. In a case where a coarse carbide (iron-based carbide) having a circle equivalent diameter of more than 0.5 μm is present in a large amount in a microstructure of the hot-stamping formed body, it serves as the origin of cracking during bending or as the origin of crack propagation.

(ii) The more the amount of the coarse carbide is reduced, the more the collision resistance characteristics (bendability and crack propagation resistance characteristics) are improved. In addition, even in a case where the coarse carbide is present, the crack propagation resistance characteristics are improved in a case where an average distance between the carbides secures at least a certain amount.

(iii) In a case where ferrite and pearlite are present in large amounts in the microstructure of the hot-stamping formed body, collision resistance characteristics (bendability and crack propagation resistance characteristics) decrease, and in a case where retained austenite is present in a large amount, crack propagation resistance characteristics decrease. In addition, in a case where a prior austenite grain size is coarse, collision resistance characteristics (bendability and crack propagation resistance characteristics) decrease.

The present invention has been contrived in view of the above findings. The gist of the present invention is as follows.

[1] A hot-stamping formed body according to an aspect of the present invention includes, as a chemical composition, by mass %: C: 0.20% to 0.70%; Si: 0.010% to 2.000%; Mn: 0% to 2.00%; P: 0.100% or less; S: 0.0100% or less; N: 0.0100% or less; O: 0.0200% or less; Al: 0.0010% to 0.5000%; Mo: 0.0010% to 1.0000%; B: 0.0005% to 0.0100%; Ti: 0.010% to 0.100%; Nb: 0% to 0.100%; Cr: 0% to 1.00%; Co: 0% to 3.00%; Ni: 0% to 3.00%; Cu: 0% to 1.00%; V: 0% to 1.000%; W: 0% to 1.00%; Ca: 0% to 1.0000%; Mg: 0% to 1.0000%; REM: 0% to 1.0000%; Sb: 0% to 1.000%; Zr: 0% to 1.000%; As: 0% to 1.000%; one or more selected from Ta, Re, Os, Ir, Tc, Pb, Se, Bi, and Sn: 0% to 1.000% in total; and a remainder: Fe and impurities, in which in a case where a range from a position at ⅛ of a thickness to a position at ⅜ of the thickness in a thickness direction from a surface is set as a ¼-depth position, a microstructure at the ¼-depth position includes, by area ratio, martensite: 80.0% or more, and retained austenite: 0.0% or more and less than 5.0%, in the microstructure at the ¼-depth position, a number density of an iron-based carbide present in the martensite and having a circle equivalent diameter of more than 0.5 μm is less than 0.050 particles/μm², and an average distance between the iron-based carbide and another iron-based carbide nearest to the iron-based carbide is 3.0 μm or more, and in the microstructure at the ¼-depth position, a prior austenite grain size is 20.0 μm or less.

[2] In the hot-stamping formed body according to [1], a decarburization index Dc may be 0.085 or more.

[3] In the hot-stamping formed body according to [1] or [2], when a range from the surface to 50 μm is set as a surface layer portion, a microstructure of the surface layer portion may include, by area ratio, ferrite: more than 5.0%.

[4] In the hot-stamping formed body according to any one of [1] to [3], the chemical composition may include, by mass %, C: more than 0.40% and 0.70% or less, Si: 0.010% to 2.000%, Mn: 0% to 1.00%, P: 0.100% or less, S: 0.0100% or less, N: 0.0100% or less, O: 0.0200% or less, Al: 0.0010% to 0.5000%, Mo: 0.0010% to 1.0000%, B: 0.0005% to 0.0100%, Ti: 0.010% to 0.100%, Nb: 0% to 0.100%, Cr: 0% to 1.00%, Co: 0% to 3.00%, Ni: 0% to 3.00%, Cu: 0% to 1.00%, V: 0% to 1.000%, W: 0% to 1.00%, Ca: 0% to 1.0000%, Mg: 0% to 1.0000%, REM: 0% to 1.0000%, Sb: 0% to 1.000%, Zr: 0% to 1.000%, As: 0% to 1.000%, one or more selected from Ta, Re, Os, Ir, Tc, Pb, Se, Bi, and Sn: 0% to 1.000% in total, and a remainder: Fe and impurities.

[5] In the hot-stamping formed body according to any one of [1] to [4], a coating may be provided on the surface.

[6] In the hot-stamping formed body according to [5], the coating may primarily contain an Fe—Al-based alloy.

[7] In the hot-stamping formed body according to [5], the coating may primarily contain an Fe—Zn-based alloy.

### Advantageous Effects of Invention

According to the above aspect of the present invention, it is possible to provide a hot-stamping formed body having high strength and excellent collision resistance characteristics.

### BRIEF DESCRIPTION OF DRAWINGS

FIG. 1 A diagram showing an example of an impact force-displacement curve obtained in an instrumented impact test.

### DESCRIPTION OF EMBODIMENTS

### <Hot-Stamping Formed Body>

A hot-stamping formed body according to an embodiment of the present invention (hot-stamping formed body according to the present embodiment) will be described.

Hereinafter, a range from a position at ⅛ of a thickness to a position at ⅜ of the thickness in a thickness direction from a surface will be described as a ¼-depth position, and a range from the surface to 50 μm will be described as a surface layer portion.

The surface serving as the reference for the surface layer portion and the ¼-depth position is a surface of the hot-stamping formed body. In a case where the hot-stamping formed body has a coating (has a base metal portion and a coating), the surface means a surface of the base metal portion excluding the coating.

The hot-stamping formed body according to the present embodiment has a predetermined chemical composition, and when a range from a position at ⅛ of a thickness to a position at ⅜ of the thickness in a thickness direction from a surface is set as a ¼-depth position, a microstructure at the ¼-depth position includes, by area ratio, martensite: 80.0% or more and retained austenite: 0.0% or more and less than 5.0%, in the microstructure at the ¼-depth position, a number density of an iron-based carbide present in the martensite and having a circle equivalent diameter of more than 0.5 μm is less than 0.050 particles/μm², and an average distance between the iron-based carbide and another iron-based carbide nearest thereto is 3.0 μm or more, and in the microstructure at the ¼-depth position, a prior austenite grain size is 20.0 μm or less.

The hot-stamping formed body according to the present embodiment may have a coating on the surface. In this case, the hot-stamping formed body has a base metal portion made of steel and a coating formed on a surface of the base metal portion. In addition, in this case, the chemical composition and the microstructure described above are the chemical composition and the microstructure of the base metal portion.

These will be described below.

### [Chemical Composition]

The hot-stamping formed body according to the present embodiment has a chemical composition including, by mass %, C: 0.20% to 0.70%, Si: 0.010% to 2.000%, Mn: 0% to 2.00%, P: 0.100% or less, S: 0.0100% or less, N: 0.0100% or less, O: 0.0200% or less, Al: 0.0010% to 0.5000%, Mo: 0.0010% to 1.0000%, B: 0.0005% to 0.0100%, Ti: 0.010% to 0.100%, Nb: 0% to 0.100%, Cr: 0% to 1.00%, Co: 0% to 3.00%, Ni: 0% to 3.00%, Cu: 0% to 1.00%, V: 0% to 1.000%, W: 0% to 1.00%, Ca: 0% to 1.0000%, Mg: 0% to 1.0000%, REM: 0% to 1.0000%, Sb: 0% to 1.000%, Zr: 0% to 1.000%, As: 0% to 1.000%, one or more selected from Ta, Re, Os, Ir, Tc, Pb, Se, Bi, and Sn: 0% to 1.000% in total, and a remainder: Fe and impurities.

Reasons for limiting the amount of each element are as follows.

Hereinafter, a range indicated by “A to B” indicates a range in which A is a lower limit and B is an upper limit (A or more and B or less). However, a value represented by “more than” or “less than” is not included as a lower limit or an upper limit. For example, “more than A to B” indicates that the value is more than A and B or less.

### C: 0.20% to 0.70%

C is an element that increases the hardenability of steel and increases the strength of a hot-stamping formed body obtained after a steel sheet is subjected to quenching such as hot stamping. In a case where the C content is less than 0.20%, it becomes difficult to secure a sufficient strength in the hot-stamping formed body. Therefore, the C content is set to 0.20% or more. The C content is preferably set to 0.30% or more, and in a case where a higher tensile strength is obtained, the C content is more preferably 0.33% or more or more than 0.40%. The C content is still more preferably more than 0.44%.

In a case where the C content is more than 0.70%, the number density and the average distance of a coarse iron-based carbide fall outside specified ranges, and thus collision resistance characteristics (bendability and crack propagation resistance characteristics) decrease. Therefore, the C content is set to 0.70% or less. The C content is set to preferably 0.60% or less, and more preferably 0.55% or less.

That is, the C content is 0.20% to 0.70%, and may be, for example, preferably 0.30% to 0.70%, more preferably more than 0.40% to 0.70%, and still more preferably more than 0.44% to 0.70%, 0.30% to 0.60%, 0.33% to 0.60%, more than 0.40% to 0.60%, more than 0.44% to 0.60%, or more than 0.44% to 0.55%.

### Si: 0.010% to 2.000%

Si is an effective element for securing the collision resistance characteristics (bendability and crack propagation resistance characteristics) of the hot-stamping formed body by increasing the hardenability of steel, suppressing an increase in the amount of a coarse iron-based carbide, and securing the number density and the average distance of the coarse iron-based carbide. In order to obtain the above effect, the Si content is set to 0.010% or more. The Si content is set to preferably 0.100% or more, and more preferably 0.200% or more.

In a case where the Si content in the steel is more than 2.000%, the amount of retained austenite increases, and crack propagation resistance characteristics decrease.

Therefore, the Si content is set to 2.000% or less. The Si content is preferably 1.500% or less, and more preferably 1.000% or less.

That is, the Si content is 0.010% to 2.000%, for example, preferably 0.100% to 1.500%, and more preferably 0.200% to 1.000%.

### Mn: 0% to 2.00%

Mn may not be contained (may be 0%), but is a very effective element for increasing the hardenability of steel and securing the strength after quenching. Furthermore, Mn is an element that lowers Ac3 (transformation point) and promotes the lowering of a quenching treatment temperature. Therefore, Mn may be contained. In a case where the above effect is obtained, the Mn content is preferably 0.05% or more, more preferably 0.15% or more, and still more preferably 0.17% or more or 0.20% or more.

In a case where the Mn content is more than 2.00%, the amount of a coarse iron-based carbide increases, the number density and the average distance of the coarse iron-based carbide cannot be satisfied, and collision resistance characteristics (bendability and crack propagation resistance characteristics) after quenching decrease. Therefore, the Mn content is set to 2.00% or less. The Mn content is preferably 1.50% or less, more preferably 1.00% or less, and still more preferably 0.80% or less or 0.60% or less.

That is, the Mn content is 0% to 2.00%, for example, preferably 0.05% to 1.50% or 0% to 1.00%, more preferably 0.15% to 1.00%, and still more preferably 0.17% to 0.80% or 0.20% to 0.60%.

### P: 0.100% or Less

P is an impurity element. In a case where P segregates at grain boundaries, the grain boundary strength decreases, and the crack propagation resistance characteristics decrease. Therefore, the P content is set to 0.100% or less. The P content is preferably 0.050% or less, 0.030% or less, or 0.020% or less.

The lower limit of the P content does not need to be particularly specified, and is 0%. However, in a case where the P content is reduced to less than 0.0001%, the dephosphorization cost increases significantly, which is not preferable economically. Therefore, the P content may be set to 0.0001% or more, 0.001% or more, 0.003% or more, or 0.005% or more.

That is, the P content is 0% to 0.100%, and for example, preferably 0.0001% to 0.100%.

### S: 0.0100% or Less

S is an impurity element and is an element that forms an inclusion in steel. Since the inclusion serves as the origin of fracture or the propagation path of crack, collision resistance characteristics (bendability and crack propagation resistance characteristics) decrease in a case where the S content is large. Therefore, the S content is set to 0.0100% or less. The S content is preferably 0.0080% or less, 0.0050% or less, 0.0030% or less, 0.0020% or less, or 0.0010% or less.

The lower limit of the S content does not need to be particularly specified, and is 0%. However, in a case where the S content is reduced to less than 0.0001%, the desulfurization cost increases significantly, which is not preferable economically. Therefore, the S content may be set to 0.0001% or more, 0.0002% or more, or 0.0003% or more.

That is, the S content is 0% to 0.0100%, and for example, preferably 0.0001% to 0.0100%.

### N: 0.0100% or Less

N is an impurity element and is an element that forms a nitride in steel. Since the nitride serves as the origin of fracture or the propagation path of crack, collision resistance characteristics (bendability and crack propagation resistance characteristics) decrease in a case where the N content is large. Therefore, the N content is set to 0.0100% or less. The N content is preferably 0.0080% or less or 0.0050% or less. The lower limit of the N content does not need to be particularly specified, and is 0%. However, in a case where the N content is reduced to less than 0.0001%, a denitrification cost increases significantly, which is not preferable economically. Therefore, the N content may be set to 0.0001% or more, 0.0004% or more, or 0.0010% or more.

That is, the N content is 0% to 0.0100%, and for example, preferably 0.0001% to 0.0100%.

### O: 0.0200% or Less

O is an impurity element and is an element that forms a coarse oxide of Al, Ti, Mg, or the like serving as the origin of fracture. In a case where the O content is large, the amount of a coarse oxide of Al, Ti, Mg, or the like increases, and the collision resistance characteristics (bendability and crack propagation resistance characteristics) of the hot-stamping formed body decrease. Therefore, the O content is set to 0.0200% or less. The O content is preferably 0.0100% or less, more preferably 0.0050% or less, and still more preferably 0.0040% or less, 0.0030% or less, or 0.0020% or less.

The lower limit of the O content does not need to be particularly specified, and is 0%. However, in a case where the O content is less than 0.0001%, the deoxidation cost increases significantly, which is not preferable economically. Therefore, the O content may be set to 0.0001% or more, 0.0005% or more, or 0.0010% or more.

That is, the O content is 0% to 0.0200%, and for example, preferably 0.0001% to 0.0200%.

### Al: 0.0010% to 0.5000%

Al is an element that has an action of deoxidizing molten steel and achieving soundness of the steel (suppressing the occurrence of defects, such as blowholes, in the steel). In a case where the Al content is less than 0.0010%, deoxidation is not sufficiently performed, the number of blowholes and the amount of a coarse oxide increase, and collision resistance characteristics (bendability and crack propagation resistance characteristics) decrease. Therefore, the Al content is set to 0.0010% or more. The Al content is preferably 0.0050% or more, 0.0100% or more, 0.0150% or more, 0.0200% or more, or 0.0250% or more.

In a case where the Al content is more than 0.5000%, the amount of a coarse oxide increases in the steel, and the collision resistance characteristics (bendability and crack propagation resistance characteristics) of the hot-stamping formed body decrease. Therefore, the Al content is set to 0.5000% or less. The Al content is preferably 0.4000% or less, 0.3000% or less, 0.2000% or less, 0.1500% or less, 0.1000% or less, or 0.0750% or less.

That is, the Al content is 0.0010% to 0.5000%, for example, preferably 0.0050% to 0.4000%, more preferably 0.0100% to 0.3500% or 0.0150% to 0.3000%, and still more preferably 0.0200% to 0.2000%, 0.0250% to 0.1500%, 0.0200% to 0.1000%, or 0.0200% to 0.0750%.

In the present embodiment, the Al content refers to a total Al content (total-Al content).

### Mo: 0.0010% to 1.0000%

Mo is an element that dissolves into prior austenite grains during heating before hot stamping and increases the strength of the hot-stamping formed body. In order to reliably obtain this effect, the Mo content is set to 0.0010% or more. The Mo content is preferably 0.0100% or more.

In a case where the Mo content is more than 1.0000%, the amount of an Mo-based inclusion increases. Since the inclusion serves as the origin of cracking or the propagation path of crack, collision resistance characteristics (bendability and crack propagation resistance characteristics) of the hot-stamping formed body decrease in a case where the Mo content is large. Therefore, the Mo content is set to 1.0000% or less. The Mo content is preferably 0.8000% or less or 0.6000% or less.

That is, the Mo content is 0.0010% to 1.0000%, and for example, preferably 0.0100% to 0.8000% or 0.0100% to 0.6000%.

### B: 0.0005% to 0.0100%

B is an element that improves the hardenability of steel. In a case where the B content is less than 0.0005%, hardenability decreases, and the amount of martensite decreases. Therefore, a desired strength cannot be obtained, and collision resistance characteristics (bendability and crack propagation resistance characteristics) decrease. Therefore, the B content is set to 0.0005% or more. The B content is preferably 0.0010% or more, and more preferably 0.0015% or more.

In a case where the B content is more than 0.0100%, the amount of a coarse nitride such as BN increases, and the collision resistance characteristics (bendability and crack propagation resistance characteristics) of the hot-stamping formed body decrease. Therefore, the B content is set to 0.0100% or less. The B content is preferably 0.0080% or less, 0.0060% or less, 0.0040% or less, or 0.0030% or less.

That is, the B content is 0.0005% to 0.0100%, for example, preferably 0.0010% to 0.0080%, and more preferably 0.0015% to 0.0060%, 0.0015% to 0.0040%, or 0.0015% to 0.0030%.

### Ti: 0.010% to 0.100%

Ti is an element that fixes nitrogen as TiN, obtains a hardenability improvement effect due to a solid solution B, and increases the strength of the hot-stamping formed body by precipitation hardening due to the formation of a fine carbide or carbonitride. In a case where the Ti content is less than 0.010%, these actions cannot be obtained. Therefore, the Ti content is set to 0.010% or more. The Ti content is preferably 0.020% or more or 0.030% or more.

In a case where the Ti content is more than 0.100%, the amount of a coarse nitride or carbonitride such as TiN or (Ti, Nb)(C, N) increases in the steel, and the collision resistance characteristics (bendability and crack propagation resistance characteristics) of the hot-stamping formed body decrease. Therefore, the Ti content is set to 0.100% or less. The Ti content is preferably 0.080% or less, 0.060% or less, 0.050% or less, or 0.040% or less.

That is, the Ti content is 0.010% to 0.100%, and may be, for example, preferably 0.020% to 0.080%, more preferably 0.030% to 0.060%, 0.030% to 0.050%, 0.010% to 0.040%, or 0.020% to 0.040%.

The chemical composition of the hot-stamping formed body according to the present embodiment may contain the above-described elements (base elements) and a remainder of Fe and impurities. One or two or more of the following elements (optional elements) may be further contained instead of a part of Fe.

### Nb: 0% to 0.100%

Nb is an element that forms a carbide or carbonitride in steel and increases the strength of the hot-stamping formed body by precipitation hardening. Therefore, Nb may be contained. In a case where the above effect is obtained, the Nb content is preferably set to 0.001% or more. The Nb content is more preferably 0.005% or more, 0.009% or more, or 0.015% or more.

In a case where the Nb content is more than 0.100%, the amount of a carbide or carbonitride such as NbC or (Nb,Ti)(C,N) increases in the steel, and the toughness of the hot-stamping formed body decreases. Therefore, the Nb content is set to 0.100% or less. The Nb content is preferably 0.080% or less, 0.060% or less, or 0.050% or less.

That is, the Nb content is 0% to 0.100%, preferably 0.001% to 0.100%, more preferably 0.005% to 0.080%, and still more preferably 0.009% to 0.060% or 0.015% to 0.050%.

### Cr: 0% to 1.00%

Cr is an element that dissolves into prior austenite grains during heating before hot stamping and increases the strength of the hot-stamping formed body. Therefore, Cr may be contained. In a case where the above effect is obtained, the Cr content is preferably set to 0.01% or more. The Cr content is more preferably 0.10% or more or 0.20% or more.

In a case where the Cr content is more than 1.00%, the hydrogen embrittlement resistance (hydrogen embrittlement resistance characteristics) of the hot-stamping formed body decreases. Therefore, the Cr content is set to 1.00% or less. The Cr content is preferably 0.70% or less, 0.65% or less, 0.60% or less, or 0.55% or less.

That is, the Cr content is 0% to 1.00%, for example, preferably 0.01% to 1.00%, more preferably 0.10% to 0.70%, and still more preferably 0.20% to 0.65%, 0.20% to 0.60%, or 0.20% to 0.55%.

### Co: 0% to 3.00%

Co is an element that increases the strength of the hot-stamping formed body by solid solution strengthening. Therefore, Co may be contained. In a case where the above effect is obtained, the Co content is preferably set to 0.01% or more. The Co content is more preferably 0.10% or more, and still more preferably 0.20% or more.

The above effect is saturated even in a case where a large amount of Co is contained. Therefore, the Co content is set to 3.00% or less. The Co content is preferably 2.50% or less. The Co content is more preferably 2.20% or less, 2.00% or less, 1.00% or less, 0.70% or less, 0.65% or less, 0.60% or less, or 0.55% or less.

That is, the Co content is 0% to 3.00%, for example, preferably 0.01% to 2.50%, more preferably 0.01% to 2.20%, 0.01% to 2.00%, 0.10% to 2.20%, 0.10% to 2.00%, or 0.20% to 2.00%, and still more preferably 0.20% to 1.00%, 0.20% to 0.70%, 0.20% to 0.65%, 0.20% to 0.60%, or 0.20% to 0.55%.

### Ni: 0% to 3.00%

Ni is an element that dissolves in austenite and is useful for increasing the hardenability of steel and a tensile strength. Therefore, Ni may be contained. In a case where the above effect is obtained, the Ni content is preferably set to 0.001% or more. The Ni content is more preferably 0.01% or more or 0.10% or more.

In a case where the Ni content is more than 3.00%, the above effect is saturated, and the alloying cost increases. Therefore, the Ni content is set to 3.00% or less. The Ni content is preferably 2.50% or less or 2.00% or less, and more preferably 1.00% or less, 0.70% or less, 0.65% or less, 0.60% or less, or 0.55% or less.

That is, the Ni content is 0% to 3.00%, for example, preferably 0.001% to 2.50% or 0.01% to 2.00%, more preferably 0.10% to 1.00%, and still more preferably 0.10% to 0.70%, 0.10% to 0.65%, 0.10% to 0.60%, or 0.10% to 0.55%.

### Cu: 0% to 1.00%

Cu is an element that has an action of dissolving into prior austenite grains during heating before hot stamping and increases the strength of the hot-stamping formed body. Therefore, Cu may be contained. In a case where the above effect is obtained, the Cu content is preferably set to 0.01% or more. The Cu content is more preferably 0.10% or more.

The above effect is saturated even in a case where a large amount of Cu is contained. Therefore, the Cu content is set to 1.00% or less. The Cu content is preferably 0.80% or less, 0.60% or less, or 0.30% or less.

That is, the Cu content is 0% to 1.00%, for example, preferably 0.01% to 0.80% or 0.01% to 0.60%, more preferably 0.10% to 0.80%, and still more preferably 0.10% to 0.60% or 0.10% to 0.30%.

### V: 0% to 1.000%

V is an element that forms a carbonitride in steel to provide an effect of increasing the strength of the hot-stamping formed body by precipitation hardening. Therefore, V may be contained. In a case where the above effect is obtained, the V content is preferably set to 0.010% or more.

In a case where the V content is set to more than 1.000%, a large amount of a carbonitride is generated in the steel, and the hydrogen embrittlement resistance of the hot-stamping formed body thus decreases. Therefore, the V content is set to 1.000% or less. The V content is preferably 0.800% or less, 0.600% or less, or 0.300% or less.

That is, the V content is 0% to 1.000%, for example, preferably 0.010% to 0.800%, more preferably 0.010% to 0.600%, and still more preferably 0.010% to 0.300%.

### W: 0% to 1.00%

W is an element that provides an effect of increasing the strength of the hot-stamping formed body. Therefore, W may be contained. In a case where the above effect is obtained, the W content is set to preferably 0.01% or more, and more preferably 0.10% or more.

The above effect is saturated even in a case where a large amount of W is contained. Therefore, the W content is set to 1.00% or less. The W content is preferably 0.80% or less, 0.60% or less, or 0.30% or less.

That is, the W content is 0% to 1.00%, for example, preferably 0.01% to 0.80%, more preferably 0.01% to 0.60%, and still more preferably 0.01% to 0.30% or 0.10% to 0.30%.

### Ca: 0% to 1.0000%

Ca is an element that suppresses the generation of a coarse oxide that serves as the origin of fracture. Therefore, Ca may be contained. In a case where the above effect is obtained, the Ca content is set to preferably 0.0001% or more, and more preferably 0.0010% or more.

The above effect is saturated even in a case where a large amount of Ca is contained. Therefore, the Ca content is set to 1.0000% or less. The Ca content is preferably 0.4000% or less, 0.1000% or less, 0.0700% or less, 0.0200% or less, or 0.0100% or less.

That is, the Ca content is 0% to 1.0000%, and for example, preferably 0.0001% to 0.4000%, 0.0001% to 0.1000%, or 0.0001% to 0.0700%, more preferably 0.0010% to 0.1000%, and even more preferably 0.0010% to 0.0700%, 0.0010% to 0.0200%, or 0.0010% to 0.0100%.

### Mg: 0% to 1.0000%

Mg is an element that forms a fine oxide or sulfide in molten steel and suppresses the formation of coarse MnS. In addition, Mg is an element that disperses a number of fine oxides to provide an effect of refining the microstructure. Therefore, Mg may be contained. In a case where the above effect is obtained, the Mg content is preferably set to 0.0001% or more.

In a case where the Mg content is more than 1.0000%, the amount of the oxide in the steel increases, which adversely affects the toughness of the hot-stamping formed body. Therefore, the Mg content is set to 1.0000% or less. The Mg content is preferably 0.4000% or less, 0.1000% or less, 0.0700% or less, 0.0200% or less, or 0.0100% or less.

That is, the Mg content is 0% to 1.0000%, for example, preferably 0.0001% to 0.4000%, more preferably 0.0001% to 0.1000%, and still more preferably 0.0001% to 0.0700%, 0.0001% to 0.0200%, 0.0001% to 0.0100%, 0.0010% to 0.1000%, 0.0010% to 0.0700%, 0.0010% to 0.0200%, or 0.0010% to 0.0100%.

### REM: 0% to 1.0000%

REM is an element that suppresses the generation of a coarse oxide that serves as the origin of fracture. Therefore, REM may be contained. In a case where the above effect is obtained, the REM content is set to preferably 0.0001% or more, and more preferably 0.0010% or more.

The above effect is saturated even in a case where a large amount of REM is contained. Therefore, the REM content is set to 1.0000% or less. The REM content is preferably 0.4000% or less, 0.1000% or less, 0.0700% or less, 0.0200% or less, or 0.0100% or less.

That is, the REM content is 0% to 1.0000%, for example, preferably 0.0001% to 1.0000%, 0.0001% to 0.4000% or 0.0001% to 0.1000%, more preferably 0.0010% to 0.1000%, and still more preferably 0.0010% to 0.0700%, 0.0010% to 0.0200%, or 0.0010% to 0.0100%.

In the present embodiment, the REM refers to a total of 17 elements including Sc, Y, and lanthanoid, and the REM content refers to the total content of these elements.

### Sb: 0% to 1.000%

Sb is an element that suppresses the generation of an oxide that serves as the origin of fracture to improve the deformability of the hot-stamping formed body. Therefore, Sb may be contained. In a case where the above effect is obtained, the Sb content is set to preferably 0.001% or more, more preferably 0.002% or more, and still more preferably 0.010% or more.

The above effect is saturated even in a case where a large amount of Sb is contained. Therefore, the Sb content is set to 1.000% or less. The Sb content is preferably 0.400% or less, 0.100% or less, 0.050% or less, or 0.020% or less.

That is, the Sb content is 0% to 1.000%, for example, preferably 0.001% to 1.000%, 0.001% to 0.400%, 0.001% to 0.100%, 0.001% to 0.050%, or 0.001% to 0.020%, more preferably 0.002% to 0.400%, 0.002% to 0.100%, or 0.010% to 0.050%, and still more preferably 0.001% to 0.020%, 0.002% to 0.020%, or 0.010% to 0.020%.

### Zr: 0% to 1.000%

Zr is an element that contributes to inclusion control, particularly to the fine dispersion of inclusion, and increases the toughness of the hot-stamping formed body. Therefore, Zr may be contained. In a case where the above effect is obtained, the Zr content is set to preferably 0.001% or more, and more preferably 0.010% or more.

In a case where a large amount of Zr is contained, surface properties may deteriorate. Therefore, the Zr content is set to 1.000% or less. The Zr content is preferably 0.400% or less, 0.200% or less, or 0.100% or less.

That is, the Zr content is 0% to 1.000%, for example, preferably 0.001% to 1.000%, 0.001% to 0.400%, 0.001% to 0.200%, or 0.001% to 0.100%, more preferably 0.010% to 0.200%, and still more preferably 0.010% to 0.100%.

### As: 0% to 1.000%

As is an element that lowers an austenitizing temperature and refines prior austenite grains, thereby contributing to the improvement in hydrogen embrittlement resistance. Therefore, As may be contained. In a case where the above effect is obtained, the As content is set to preferably 0.001% or more, and more preferably 0.005% or more.

The above effect is saturated even in a case where a large amount of As is contained. Therefore, the As content is set to 1.000% or less. The As content is preferably 0.400% or less, 0.200% or less, or 0.100% or less.

That is, the As content is 0% to 1.000%, for example, preferably 0.001% to 1.000%, 0.001% to 0.400%, or 0.005% to 0.400%, more preferably 0.001% to 0.200% or 0.005% to 0.400%, and still more preferably 0.001% to 0.100% or 0.005% to 0.100%.

One or More Selected from Ta, Re, Os, Ir, Tc, Pb, Se, Bi, and Sn: 0% to 1.000% in total

Ta, Re, Os, Ir, Tc, Pb, Se, Bi, and Sn are elements that improve hydrogen embrittlement resistance. Therefore, they may be contained. In a case where the above effect is obtained, the total content is preferably set to 0.010% or more.

In a case where the total amount of these elements is more than 1.000%, the effect is saturated and the cost increases. Therefore, in a case where they are contained, the total content is set to 1.000% or less. The total content is preferably 0.800% or less, and more preferably 0.500% or less, 0.400% or less, 0.200% or less, or 0.100% or less.

That is, the total amount of one or more selected from Ta, Re, Os, Ir, Tc, Pb, Se, Bi, and Sn is 0% to 1.000%, for example, preferably 0.010% to 0.800%, more preferably 0.010% to 0.500%, and still more preferably 0.010% to 0.400%, 0.010% to 0.200%, or 0.010% to 0.100%.

As described above, the chemical composition of the hot-stamping formed body according to the present embodiment contains base elements and a remainder of Fe and impurities, or contains base elements, one or two or more of optional elements, and a remainder of Fe and impurities.

Examples of the impurities include elements that are mixed from a steel raw material or scrap and/or during steelmaking and are allowed in a range where the characteristics of the hot-stamping formed body according to the present embodiment do not deteriorate.

The chemical composition of the hot-stamping formed body described above may be measured by a general analysis method after a decarburized layer described later is cut by mechanical grinding or the like. For example, the chemical composition may be measured using inductively coupled plasma-atomic emission spectrometry (ICP-AES). Elements that are difficult to measure with ICP-AES are measured by other methods. For example, C and S may be measured using a combustion-infrared absorption method, N may be measured using an inert gas fusion-thermal conductivity method, and O may be measured using an inert gas fusion-nondispersive infrared absorption method. Tc may be measured using inductively coupled plasma-mass spectrometry (ICP-MS).

In a case where the hot-stamping formed body has a coating on a surface, a chemical composition of the base metal portion may be analyzed after the coating and the decarburized layer are removed by mechanical grinding.

### [Microstructure]

<Microstructure at ¼-Depth Position Includes, by Area Ratio, Martensite: 80.0% or More and Retained Austenite: 0.0% or More and Less than 5.0%>

In a case where the area ratio of martensite is less than a predetermined amount and a large amount of ferrite, pearlite, or bainite is present, collision resistance characteristics (bendability and crack propagation resistance characteristics) decrease. In addition, the tensile strength also decreases. Therefore, the area ratio of martensite is set to 80.0% or more (including 100.0%). In the present embodiment, martensite includes so-called fresh martensite and tempered martensite (including self-tempered martensite). In order to further improve the collision resistance characteristics (bendability and crack propagation resistance characteristics), the area ratio of martensite is preferably 85.0% or more, more preferably 90.0% or more, and still more preferably 95.0% or more.

That is, the area of martensite is 80.0% or more (to 100.0%), for example, preferably 85.0% to 100.0%, more preferably 90.0% to 100.0%, and still more preferably 95.0% to 100.0%.

In addition, retained austenite is transformed into hard martensite by strain-induced transformation during deformation by collision. Therefore, in a case where the area ratio of retained austenite is large, the crack propagation resistance characteristics decrease. In the hot-stamping formed body according to the present embodiment, the area ratio of retained austenite is set to less than 5.0% (including 0.0%). In order to further improve the crack propagation resistance characteristics, the area ratio of retained austenite is preferably less than 4.0%, and more preferably less than 2.0%. That is, the area ratio of retained austenite is 0.0% or more and less than 5.0%, preferably 0.0% or more and less than 4.0%, and more preferably 0.0% or more and less than 2.0%.

The remainder of the microstructure other than the martensite and the retained austenite includes ferrite, pearlite, and/or bainite.

The area ratio thereof may be 20.0% or less (including 0.0%) in total to secure 80.0% or more of martensite. The area ratio of the martensite is preferably less than 20.0%, more preferably 15.0% or less, and still more preferably 10.0% or less or 5.0% or less.

In the microstructure, the area ratio of each microstructure (each phase) can be obtained by the following method.

From any position 50 mm or more away from an end portion of the hot-stamping formed body (in a case where a sample cannot be collected from this position, from a position avoiding the end portion), a sample is cut out in a cross section parallel to a rolling direction and a thickness direction (sheet thickness direction of the base steel sheet) so that a microstructure at a ¼-depth position (a range from a position at ⅛ of the thickness from the surface to a position at ⅜ of the thickness from the surface in the thickness direction) can be observed. The size of the sample depends on a measurement device, but is set to a size that can be observed by about 10 mm in the rolling direction.

The identification of the microstructure is performed by the following method using the above-described sample.

The cross section (observation surface) parallel to the rolling direction and the thickness direction is polished with #600 to #1500 silicon carbide paper, and then mirror-finished using a liquid obtained by dispersing a diamond powder having a particle size of 1 to 6 μm in a diluted solution of an alcohol or the like or pure water. Then, the cross section is polished for 8 minutes using colloidal silica having a grain size of 0.25 μm and containing no alkaline solution at room temperature, to remove strain introduced into a surface layer of the sample. At any position in the longitudinal direction of the sample cross section, a range of 200 μm in length in the rolling direction from a position at ⅛ of the thickness from the surface to a position at ⅜ of the thickness from the surface with a position at ¼ of the thickness from the surface as a center is measured at measurement intervals of 0.1 μm by an electron backscatter diffraction method to obtain crystal orientation information. For the measurement, an EBSD analysis device composed of a thermal field-emission scanning electron microscope (JSM-7001F manufactured by JEOL Ltd.) and an EBSD detector (Hikari detector manufactured by AMETEK, Inc.) is used. In this case, the degree of vacuum inside the EBSD analysis device is set to 9.6×10⁻⁵ Pa or less, the acceleration voltage is set to 20 kV, the operating distance (WD) is set to 15 mm, the irradiation current level is set to 18. In collecting an EBSD pattern, in the function of software “OIM Data Collection” attached to the EBSD analysis device, camera settings are set so that the exposure time is 3.65 and the gain is 0.39. In addition, in detecting a band of an EBSD pattern, the max peak count of the Hough transform is set to 9, and the min peak count is set to 5. For the analysis, a database of a bcc crystal structure, Iron (Alpha), and a database of an fcc structure, Iron (Gamma), are selected. In a case where the structure to be analyzed has a bct crystal structure, it is analyzed as a bcc structure.

For the obtained crystal orientation information, a region having an fcc crystal structure is determined as retained austenite using a “Phase Map” function provided in software “OIM Analysis (registered trademark)” attached to the EBSD analysis device. The area ratio of the retained austenite is calculated to obtain the area ratio of retained austenite. Next, regions having a bcc crystal structure are determined as bainite, ferrite, pearlite, and martensite (fresh martensite and tempered martensite). For these regions, using a “Grain Orientation Spread Map” function provided in the above-described “OIM Analysis (registered trademark)”, a region with a “Grain Orientation Spread” of 1° or less is extracted as ferrite under the condition that a grain boundary with a crystal misorientation of 15° or more is regarded as a crystal grain boundary (15°-grain boundary). The area ratio of the extracted ferrite is calculated to obtain the area ratio of ferrite.

Next, using a “Highlight” function provided in the above-described “OIM Analysis (registered trademark)”, the ferrite region (region with a “Grain Orientation Spread” of 1° or less) and the remainder region (region with a “Grain Orientation Spread” of more than) 1° are separated. Next, in the ferrite region (region with a “Grain Orientation Spread” of 1° or less), a maximum value Iα of “Grain Average IQ” of the ferrite region is obtained using a “Grain Average IQ MAP” function provided in the above-described “OIM Analysis (registered trademark)” under the condition that a 15°-grain boundary is regarded as a crystal grain boundary. Next, in the remainder region (region with a “Grain Orientation Spread” of more than 1°), a region of more than Iα/2 is extracted as “bainite and pearlite”, and a region of Iα/2 or less is extracted as “martensite (fresh martensite and tempered martensite)” using the “Grain Average IQ MAP” function provided in the above-described “OIM Analysis (registered trademark)” under the condition that a 15°-grain boundary is regarded as a crystal grain boundary. The area ratio of the extracted “bainite and pearlite” and the area ratio of the extracted “martensite (fresh martensite and tempered martensite)” are calculated to obtain the area ratio of “bainite and pearlite” and the area ratio of “martensite (fresh martensite and tempered martensite)”

The area ratio of each microstructure can be obtained by the functions of “Phase MAP”, “Grain Orientation Spread MAP”, and “Grain Average IQ MAP” provided in the above-described “OIM Analysis (registered trademark)”.

Here, in a case where the area ratio of ferrite is 0%, a separate sample is collected from the hot-stamping formed body to be measured, heated to a temperature of Ac3-70° C., held for 10 minutes in the above temperature range, and then subjected to a heat treatment for quenching at an average cooling rate of 100° C./s or more from the above temperature range to room temperature to generate ferrite. Iα of ferrite is obtained with the sample by the above procedure. Using the obtained Iα of ferrite, the area ratios of bainite, pearlite, and martensite in the hot-stamping formed body to be measured are obtained by the above procedure.

In order to observe the same region as the EBSD measurement region by SEM, a Vickers indentation is imprinted in the vicinity of an observation position. Then, the same region including the Vickers indentation is polished to remove the contamination on the surface layer, and Nital etching is performed thereon. Next, the same visual field as the EBSD observation surface is observed at a magnification of 3,000 times in a secondary electron image with an acceleration voltage set to 15 kV using a thermal field-emission scanning electron microscope (FE-SEM: JSM-7001F manufactured by JEOL Ltd.). Through the observation, the position of a microstructure corresponding to the position determined as martensite in the microstructure identification by EBSD described above is specified.

Here, in a case where the rolling direction of the hot-stamping formed body is not clear, the rolling direction is first determined by the following method before the sample is cut out so that a cross section parallel to the rolling direction and the thickness direction can be observed.

A test piece is collected from any position 50 mm or more away from an end portion of the hot-stamping formed body so that a cross section parallel to the thickness direction can be observed. The cross section of the collected sample is finished by mirror polishing, and then observed at each of magnifications of 100 times, 200 times, 500 times, and 1,000 times using an optical microscope. An observation result at an appropriate magnification at which dimensions of the inclusion can be measured is selected according to the dimensions of the inclusion. As an observation range, a range having a width of 500 μm or more in the overall sheet thickness is set, and a region having a low luminance is determined as an inclusion. During the observation, the observation may be performed within a plurality of visual fields so that at least two inclusions can be observed. Next, a surface parallel to a surface rotated in increments of 5° in a range of 0° to 180° about the sheet thickness direction as an axis is observed by the above-described method with reference to the cross section initially observed by the above-described method. Regarding each of inclusions in the obtained cross sections, a maximum length thereof is set as the length of the inclusion, and the length of the inclusion in a direction perpendicular to the direction of the maximum length is set as the thickness of the inclusion. The average value of the aspect ratios (length/thickness) of the plurality of inclusions is calculated for each cross section, and the cross section in which the average value of the aspect ratios of the inclusions is the largest is specified. A direction parallel to the longitudinal direction of the inclusion in the cross section is determined as a rolling direction.

<In Microstructure at ¼-Depth Position, Number Density of Iron-Based Carbide Present in Martensite and Having Circle Equivalent Diameter of More than 0.5 μm is Less than 0.050 Particles/μm²>

In a case where a coarse carbide (iron-based carbide) present in martensite and having a circle equivalent diameter of more than 0.5 μm is present in a large amount, it serves as the origin of cracking during bending or as the origin of crack propagation. Therefore, in the hot-stamping formed body according to the present embodiment, the number density of such a coarse iron-based carbide is reduced. Specifically, in a case where the number density of the iron-based carbide (iron-based carbide having a circle equivalent diameter of more than 0.5 μm) present in martensite and having a circle equivalent diameter of more than 0.5 μm is 0.050 particles/μm² or more, collision resistance characteristics (bendability and crack propagation resistance characteristics) significantly decrease. Therefore, the number density of the iron-based carbide present in martensite and having a circle equivalent diameter of more than 0.5 μm is set to less than 0.050 particles/μm². From the viewpoint of further improving the collision resistance characteristics (bendability and crack propagation resistance characteristics), the number density is preferably less than 0.030 particles/μm², more preferably less than 0.020 particles/μm², and still more preferably less than 0.010 particles/μm².

The more coarse iron-based carbides are reduced, the more the collision resistance characteristics (bendability and crack propagation resistance characteristics) improve, and thus the lower limit of the number density is not limited. However, since it is not easy to set the number density to 0 piece/μm², the lower limit may be set to 0.0001 particles/μm². The number density is more preferably 0.001 particles/μm² or more, and still more preferably 0.002 particles/μm² or more, 0.003 particles/μm² or more, or 0.005 particles/μm² or more. That is, the number density of the iron-based carbide present in martensite and having a circle equivalent diameter of more than 0.5 μm may be, for example, 0.0001 particles/μm² or more and less than 0.050 particles/μm², 0.001 particles/μm² or more and less than 0.050 particles/μm², 0.001 particles/μm² or more and less than 0.030 particles/μm², 0.002 particles/μm² or more and less than 0.030 particles/μm², 0.003 particles/μm² or more and less than 0.020 particles/μm², or 0.005 particles/μm² or more and less than 0.010 particles/μm².

<In Microstructure at ¼-Depth Position, Average Distance Between Iron-Based Carbide Present in Martensite and Having Circle Equivalent Diameter of More Than 0.5 μm and Another Iron-Based Carbide Nearest Thereto Present in Martensite and Having Circle Equivalent Diameter of More than 0.5 μm is 3.0 μm or More>

Even in a case where the above-described coarse iron-based carbide is present, crack propagation resistance characteristics are improved in a case where an average inter-carbide distance between coarse iron-based carbides secures at least a certain amount.

Therefore, in the hot-stamping formed body according to the present embodiment, the average distance between an iron-based carbide present in martensite and having a circle equivalent diameter of more than 0.5 μm and another iron-based carbide nearest thereto present in martensite and having a circle equivalent diameter of more than 0.5 μm is set to 3.0 μm or more. That is, in the hot-stamping formed body according to the present embodiment, crack propagation resistance characteristics are improved by reducing the presence of the adjacent coarse iron-based carbides. The average distance is preferably 5.0 μm or more, and more preferably 8.0 μm or more. The upper limit of the average distance is not limited, and the average distance may be 30.0 μm or less. The average distance is preferably 20.0 μm or less or 15.0 μm or less. That is, the average distance is 3.0 μm or more, and may be, for example, 3.0 to 30.0 μm, 5.0 to 30.0 μm, 5.0 to 20.0 μm, 5.0 to 15.0 μm, or 8.0 to 30.0 μm.

The identification of the iron-based carbide and the measurement of the circle equivalent diameter of the iron-based carbide, the number density of the iron-based carbide having a circle equivalent diameter of more than 0.5 μm, and the average distance between an iron-based carbide having a circle equivalent diameter of more than 0.5 μm and another iron-based carbide nearest thereto having a circle equivalent diameter of more than 0.5 μm can be performed by the following methods.

For the identification of the iron-based carbide, the microstructure is identified by the above-described FE-SEM, and the same sample with an indentation is used and observed with a scanning transmission electron microscope (STEM: JEM-2100 manufactured by JEOL Ltd.). Within a visual field in which the microstructure is observed, in a range of 200 μm in length in the rolling direction from a position at ⅛ of the thickness from the surface to a position at ⅜ of the thickness with a position at ¼ of the thickness from the surface in the thickness direction as a center, precipitates are extracted by an extraction replica method. For the extraction of the precipitates, the observation surface on which the microstructure is observed by FE-SEM as described above is subjected to carbon deposition, and immersed in a peeling liquid to elute only the base metal. The floating replica film is washed and collected on a grid. In the range (excluding the grid portion) identified as martensite in the microstructure, the extracted precipitates are observed at a magnification of 5,000 times using a scanning transmission electron microscope (STEM), and point analysis is performed by energy dispersive X-ray spectroscopy (EDX: JED-2300T manufactured by JEOL Ltd.) attached to the microscope. The point analysis is performed at a centroid position (centroid obtained from the observed image (planar shape)) of the observed precipitates. Quantitative analysis of the precipitates by EDX is performed for Fe and all other alloying elements described above excluding C, N, B, O, P, and S, and precipitates containing 70 mass % or more of iron (Fe) are determined as an iron-based carbide. The observation of the precipitates by STEM is performed with an acceleration voltage of 200 kV, and the point analysis of the precipitates by EDX is performed with an irradiation current of 2.56 nA and a measurement time of 60 seconds at each point. The observation is performed on 5 or more visual fields in 200 μm² or more/visual field.

The circle equivalent diameter of the precipitates determined as the iron-based carbide is obtained. In that case, a maximum length of the iron-based carbide is regarded as a major axis, a minimum length is regarded as a minor axis, and the value calculated as (major axis×minor axis)^{0.5} from the major axis and the minor axis of the iron-based carbide is defined as the circle equivalent diameter.

Here, the maximum length is the maximum length of an interval between two parallel lines that are in contact with the outer periphery of the iron-based carbide interposed between the parallel lines. The minimum length is the minimum length of the interval between the above-described two parallel lines that are in contact with the outer periphery of the iron-based carbide interposed between the parallel lines. In the carbides, the carbide having a circle equivalent diameter of more than 0.5 μm is extracted, and the number density thereof in each visual field is calculated by dividing the quantity by the area in each visual field. The average value of the number densities is set as the number density of the iron-based carbide having a circle equivalent diameter of more than 0.5 μm in the hot-stamping formed body according to the present embodiment.

In addition, a distance between the iron-based carbides having a circle equivalent diameter of more than 0.5 μm is measured, and a distance between the closest carbides is determined in each visual field. Specifically, iron-based carbides larger than 0.5 μm are extracted, and centroid coordinates thereof are calculated. Next, one iron-based carbide is optionally selected, and particles are searched radially from the centroid coordinates of the iron-based carbide. In this case, a step angle for radial searching is set to 1 degree or less. Regarding all the carbides detected from the step angle, a shortest distance between the outer peripheries (edges) of the carbides is obtained and provided as a measurement value. This process is performed on all the detected carbides to obtain a distance between the closest carbides. In the above-described method, the average value of the distances between the closest carbides measured in the visual fields is set as the average distance between the closest iron-based carbides.

### <In Microstructure at ¼-Depth Position, Prior Austenite Grain Size is 20.0 μm or Less>

In a case where prior austenite grains are coarse, collision resistance characteristics (bendability and crack propagation resistance characteristics) decrease. Therefore, in the hot-stamping formed body according to the present embodiment, the prior austenite grain size is set to 20.0 μm or less. From the viewpoint of further improving the collision resistance characteristics (bendability and crack propagation resistance characteristics), the prior austenite grain size is preferably 15.0 μm or less, and more preferably 13.0 μm or less, 12.0 μm or less, 11.0 μm or less, or 10.0 μm or less. The lower limit of the prior austenite grain size is not particularly limited, but in order to improve the hardenability of the hot-stamping formed body in a hot stamping step and to obtain a predetermined martensite fraction, the prior austenite grain size is preferably 2.0 μm or more, and more preferably 3.0 μm or more.

That is, the prior austenite grain size is 20.0 μm or less, and may be, for example, 2.0 to 20.0 μm, 2.0 to 15.0 μm, 3.0 to 15.0 μm, 3.0 to 13.0 μm, 3.0 to 12.0 μm, 3.0 to 11.0 μm, or 3.0 to 10.0 μm.

The prior austenite grain size (prior y grain size) can be obtained by the following method.

From any position 50 mm or more away from an end portion of the hot-stamping formed body (in a case where a sample cannot be collected from this position, from a position avoiding the end portion), a sample is cut out so that a cross section parallel to the rolling direction and the thickness direction can be observed. The size of the sample depends on a measurement device, but is set to a size that can be observed by about 10 mm in the rolling direction.

A cross section of the sample that serves as an observation surface is polished using #600 to #1500 silicon carbide paper, and then mirror-finished using a liquid obtained by dispersing a diamond powder having a particle size of 1 μm to 6 μm in a diluted solution of an alcohol or the like or pure water. Next, electrolytic polishing is performed to finish the observation surface. At any position in the longitudinal direction of the sample cross section, a range of 200 μm in length from a position at ⅛ of the thickness from the surface to a position at ⅜ of the thickness with a position at ¼ of the thickness from the surface as a center is measured at measurement intervals of 0.1 μm by an electron backscatter diffraction method to obtain crystal orientation information. For the measurement, an EBSD analysis device composed of a thermal field-emission scanning electron microscope and an EBSD detector may be used, and as the device, an EBSD analysis device composed of JSM-7001F manufactured by JEOL

Ltd. and a Hikari detector manufactured by AMETEK, Inc. may be used. In this case, the degree of vacuum inside the EBSD analysis device is set to 9.6×10⁻⁵ Pa or less, the acceleration voltage is set to 20 kV, the operating distance (WD) is set to 15 mm, the irradiation current level is set to 18. In collecting an EBSD pattern, in the function of software “OIM Data Collection” attached to the EBSD analysis device, camera settings are set so that the exposure time is 3.65 and the gain is 0.39. In addition, in detecting a band of an EBSD pattern, the max peak count of the Hough transform is set to 9, and the min peak count is set to 5. For the analysis, a database of a bcc crystal structure, Iron (Alpha), and a database of an fcc structure, Iron (Gamma), are selected. In a case where the structure to be analyzed has a bct crystal structure, it is analyzed as a bcc structure.

Using the obtained crystal orientation information, the crystal orientation of prior austenite grains is calculated from a crystal orientation relationship between the prior austenite grains and crystal grains having a bcc structure after transformation, and the average grain size of the prior austenite grains is calculated using the calculated crystal orientation.

The crystal orientation of the prior austenite grains is calculated by the following method. First, a crystal orientation map of the prior austenite grains is created by the method described in P. 24 to 30 of SHINNITTETSU SUMIKIN GIHO No. 404 (2016). Analysis is performed under the conditions in which the orientation relationship between ferrite (bcc structure) and austenite (fcc structure) is provided such that an allowable angle is 3 degrees or less from the K-S relationship, and an allowable error of the orientation difference between austenite crystals determined as common austenite is 5 degrees or less in the reconstruction of the austenite microstructure, and the austenite microstructure before the phase transformation is reconstructed. The grain boundaries of the reconstructed austenite are determined to have an orientation difference of 15 degrees or more between adjacent crystal grains. In addition, except for the prior austenite grains where the entire crystal grains are not included in the photographing visual field, such as an end portion of the photographing visual field, analysis is performed with “Area Fraction” of the “Grain Size (diameter)” chart in the above-described “OIM Analysis (registered trademark)” to obtain the average grain size of the prior austenite grains.

### <Decarburization Index Dc is Preferably 0.085 or More>

In addition to the above-described microstructure control, a decarburized layer that is present in a certain range from the surface of the hot-stamping formed body makes it possible to further improve collision resistance characteristics (bendability and crack propagation resistance characteristics).

In the related art, items evaluated in the decarburized layer include a thickness of the decarburized layer, a hardness distribution in the decarburized layer, and the like. However, according to the studies by the present inventors, it has been found that these items are correlated with the collision resistance characteristics (bendability and crack propagation resistance characteristics), but the collision resistance characteristics (bendability and crack propagation resistance characteristics) may not necessarily be improved only by controlling these items. For example, as a result of the studies by the present inventors, it has been found that even in a case where the thickness (decarburization depth) of the decarburized layer is the same, in a case where a surface layer region has a steep hardness distribution (the degree of change in hardness is large), the improvement in bendability is smaller than in a case of a gradual hardness distribution, and the correlation with the thickness (decarburization depth) of the decarburized layer is weak.

Therefore, in the hot-stamping formed body according to the present embodiment, a decarburization index is used as a new index, and the collision resistance characteristics are further improved than in the related art by controlling the new index. Since this index takes into account the hardness information of the surface layer region in addition to the thickness (decarburization depth) of the decarburized layer, it has a high correlation with collision resistance performance.

Specifically, a decarburization index De is set to 0.085 or more. This decarburization index is an index for quantifying the amount of carbon loss from the surface of the hot-stamping formed body to a position 200 μm away therefrom. From the viewpoint of securing bendability, the decarburization index Dc is preferably 0.100 or more, and more preferably 0.120 or more, 0.130 or more, 0.140 or more, or 0.150 or more.

Due to the calculation method of the decarburization index Dc, the upper limit is 1.000. The decarburization index Dc is preferably 0.800 or less from the viewpoint of securing a tensile strength. The decarburization index Dc is more preferably 0.500 or less, and still more preferably 0.200 or less.

That is, Dc is 0.085 or more, and may be 0.085 or more and 0.800 or less, 0.085 or more and 0.800 or less, 0.100 or more and 0.800 or less, 0.085 or more and 0.500 or less, 0.085 or more and 0.200 or less, 0.100 or more and 0.500 or less, 0.120 or more and 0.500 or less, 0.130 or more and 0.500 or less, 0.140 or more and 0.200 or less, 0.150 or more and 0.500 or less, or 0.150 or more and 0.200 or less.

The decarburization index Dc can be obtained by the following method.

An element concentration distribution in the sheet thickness direction in the hot-stamping formed body is measured using a glow discharge emission analyzer (glow discharge optical emission spectrometry, GD-OES). Here, as a measurement range, a range from the surface of the hot-stamping formed body to a position 200 μm away from the surface (200 μm-depth position) is set, and a measurement interval is set to 0.02 μm or less. The measurement is performed on all the elements included in the hot-stamping formed body.

In a case where the hot-stamping formed body has a coating on a surface, the surface mentioned herein is an interface between the coating and the base metal portion. In a case where the hot-stamping formed body has a coating on a surface, the whole or a part of the coating is removed by mechanical polishing or chemical polishing so that it is possible to perform the measurement to the 200 μm-depth position from the surface of the base metal portion (interface between the base metal portion and the coating), and GD-OES measurement is performed. In the GD-OES measurement, a region having an Fe concentration (Fe content) of 90 mass % or more is regarded as the base metal portion, and a measurement point where the Fe concentration first becomes 90 mass % or more from the surface is regarded as the surface of the base metal portion.

Next, regarding C concentration (C content) measurement values (1,000 points or more) from a position 180 μm away from the surface of the hot-stamping formed body (180 μm-depth position) to the 200 μm-depth position, the average value thereof is calculated and regarded as the C concentration of a part where the influence of decarburization is not exerted.

However, in a case where the measurement can be performed to a depth at which the C content can be determined to reach the same level as the average C content of the base metal (a part that is not affected by decarburization), the measurement range may be set to a surface side from the 200 μm-depth position (however, the measurement is performed 50 μm or more away from the surface). In that case, regarding the C concentration measurement value in a region of up to 20 μm from a deepest portion analyzed toward a surface layer side, in a case where the absolute value of a difference between the average value of the C concentrations in the region of up to 20 μm from the deepest portion toward the surface layer side and the maximum value of the C concentration measurement values in the region of 20 μm from the deepest portion toward the surface layer side is 0.05 mass % or less, and the absolute value of a difference between the average value of the C concentrations in the region of 20 μm from the deepest portion toward the surface layer side and the minimum value of the C concentration measurement values in the region of 20 μm from the deepest portion toward the surface layer side is 0.05 mass % or less, the average value of the C concentrations in the region of 20 μm from the deepest portion toward the surface layer side may be set as the C concentration of the part that is not affected by decarburization. In a case where the deepest portion is 120 μm deep, the phrase “C concentration measurement value in the region of up to 20 μm from the deepest portion toward the surface layer side” means the concentration of C contained from the position that is 100 μm deep to the position that is 120 μm deep.

In a region from the surface of the hot-stamping formed body to a position where the C concentration is the C concentration at a position where decarburization does not occur, the amount of decrease in C concentration per unit depth (a value obtained by subtracting the C concentration at each measurement point from the C concentration at the position where decarburization does not occur) is calculated, and an integrated value of the product of the unit depth and the amount of decrease in C concentration is obtained and set as the area of the C-deficient region (area A). Here, the unit depth means a measurement interval of GD-OES. Next, the product of the C concentration at the position where decarburization does not occur and 200 (μm) is set as a reference area (area B), and a value (area A/area B) obtained by dividing the C-deficient area (area A) by the reference area (area B) is set as a decarburization index Dc.

In addition, in the present embodiment, as a result of analysis with GDS, a distance from the surface to the position where the C content is initially determined to be the same level as the average C content of the base metal (C concentration at the position that is determined to be a part that is not affected by decarburization) is defined as the decarburization depth (a range of 50 μm or more from the surface is analyzed).

In the hot-stamping formed body according to the present embodiment, the decarburization depth is preferably 180 μm or less from the viewpoint of productivity. The decarburization depth is more preferably 150 μm or less. Otherwise, the decarburization depth may be set to a thickness less than ⅛ of the thickness of a flat portion of the formed body. The decarburization depth is preferably 10 μm or more.

<Microstructure of Surface Layer Portion Preferably Includes, by Area Ratio, Ferrite: More than 5.0%>

In a case where the surface layer portion of the formed body includes a microstructure that is softer than the inside in a certain amount or more and the microstructure of the surface layer portion is appropriately controlled, it is possible to further improve collision resistance characteristics (bendability and crack propagation resistance characteristics). Therefore, the area ratio of ferrite in the microstructure of the surface layer portion is preferably set to more than 5.0%.

The area ratio of ferrite is preferably 10.0% or more, and more preferably 20.0% or more.

In the microstructure of the surface layer portion, the remainder other than ferrite includes more than 5.0% of martensite (fresh martensite and tempered martensite) and/or bainite, and less than 5.0% of retained austenite and pearlite in total.

The microstructure of the surface layer portion may be observed in the same manner as at the ¼-depth position, and each area ratio may be measured. Regarding a measurement position, a range from the surface to 50 μm in the thickness direction is set, instead of the ¼-depth position.

### [Coating]

The whole or a part of the surface of the hot-stamping formed body according to the present embodiment may have a coating.

The coating may be a coating (Fe—Al-based coating) primarily containing an Fe—Al-based alloy or a coating (Fe—Zn-based coating) primarily containing an Fe—Zn-based alloy. The coating is also referred to as a membrane, an alloyed plating layer, or an intermetallic compound layer.

The coating primarily containing an Fe—Al-based alloy is a coating containing 70 mass % or more of Fe and Al in total, and the coating primarily containing an Fe—Zn-based alloy is a coating containing 70 mass % or more of Fe and Zn in total. The coating primarily containing an Fe—Al-based alloy may further contain, in addition to Fe and Al, Si, Mg, Ca, Sr, Ni, Cu, Mo, Mn, Cr, C, Nb, Ti, B, V, Sn, W, Sb, Zn, Co, In, Bi, Zr, Se, As, REM, and a remainder of impurities. The coating primarily containing an Fe—Zn-based alloy may further contain, in addition to Fe and Zn, Si, Mg, Ca, Sr, Ni, Cu, Mo, Mn, Cr, C, Nb, Ti, B, V, Sn, W, Sb, Al, Co, In, Bi, Zr, Se, As, REM, and a remainder of impurities.

By providing the coating, corrosion resistance is obtained, so that an effect of improving hydrogen embrittlement resistance in use in a vehicle can be obtained. The thickness of the coating is preferably 10 to 100 μm.

Such a coating, for example, a coating primarily containing an Fe—Al alloy is formed by performing a heat treatment such as hot stamping on a steel sheet including a coating (Al-based coating) primarily containing Al. In addition, a coating primarily containing an Fe—Zn-based alloy is formed by performing a heat treatment such as hot stamping on a steel sheet including a coating (Zn-based coating) primarily containing Zn.

The coating primarily containing Al is a coating containing 70 mass % or more of Al, and the coating primarily containing Zn is a coating containing 70 mass % or more of Zn. The coating primarily containing Al may further contain, in addition to Al, Si, Mg, Ca, Sr, Ni, Cu, Mo, Mn, Cr, C, Nb, Ti, B, V, Sn, W, Sb, Zn, Co, In, Bi, Zr, Se, As, REM, and a remainder of impurities. The coating primarily containing Zn may further contain, in addition to Zn, Si, Mg, Ca, Sr, Ni, Cu, Mo, Mn, Cr, C, Nb, Ti, B, V, Sn, W, Sb, Al, Co, In, Bi, Zr, Se, As, REM, and a remainder of impurities.

The chemical composition and the thickness of the coating can be obtained by performing line analysis (qualitative analysis and quantitative analysis described below) on a cross section using a field-emission electron beam microanalyzer (FE-EPMA).

Specifically, from any position 50 mm or more away from an end portion of the hot-stamping formed body (in a case where a sample cannot be collected from this position, from a position avoiding the end portion), a sample is cut out so that a cross section parallel to the rolling direction and the thickness direction can be observed. The size of the sample depends on a measurement device, but is set to a size that can be observed by about 10 mm in the rolling direction. Next, the cross section (observation surface) parallel to the rolling direction and the thickness direction is polished with #600 to #1500 silicon carbide paper, and then mirror-finished using a liquid obtained by dispersing a diamond powder having a particle size of 1 to 6 μm in a diluted solution of an alcohol or the like or pure water. The sample is subjected to line analysis using FE-EPMA. In an observation range using FE-EPMA (JXA-8530F manufactured by JEOL Ltd.), the amounts of the elements are quantitatively analyzed by line analysis at a magnification of 500 times.

In FE-EPMA, the acceleration voltage is set to 15 kV, the beam diameter is set to 100 nm, and the entire wavelength region is subjected to line analysis (qualitative analysis) by a rapid scanning method to detect the elements contained. Next, the same conditions are set for the acceleration voltage and the beam diameter, the irradiation time per point is set to 1,000 ms, and the measurement pitch is set to 60 nm. Then, regarding a length of 200 μm in the depth direction of the sheet thickness from the surface of the coating, line analysis (quantitative analysis) is performed by a ZAF method on the elements Fe, Al, Zn, and Si and other elements detected by the above-described qualitative analysis, and the quantitative values of the elements are obtained. A region where the Fe concentration is 90 mass % or more is determined as the base metal, and a region where the Fe concentration is less than 90 mass % is determined as the coating. A distance in the depth direction from the surface of the coating to the position where the Fe concentration first becomes 90 mass % or more is measured and set as a thickness of the coating.

The thickness of the coating described above is measured five times at positions in which the distance between measurement points is 10 μm or more in one visual field. The measurement is performed in any 10 visual fields. The average value of the coating thicknesses obtained by the above-described total 50 measurements is determined as the thickness of the coating.

The chemical composition of the coating is obtained in the course of measuring the thickness of the coating described above. Specifically, in the quantitative analysis for measuring the thickness of the coating described above, in the range from the “surface of the coating” to the “position where the Fe concentration first becomes less than 90 mass %”, the average value of each element is calculated with respect to the elements Fe, Al, Zn, and Si analyzed and other elements detected by the above-described qualitative analysis, and the chemical composition of the coating is obtained. The measurement is performed five times at positions in which the distance between measurement points is 10 μm or more in one visual field. The measurement is performed in any 10 visual fields. The chemical composition of the coating obtained for each measurement is averaged over a total of 50 measurements, and this is set as the chemical composition of the coating.

### [Characteristics]

### (Tensile Strength)

In the hot-stamping formed body according to the present embodiment, the tensile strength is preferably 1,500 MPa or more in consideration of contribution to the weight reduction of the vehicle body of a vehicle. The tensile strength is preferably 1,800 MPa or more, more preferably 2,000 MPa or more, and still more preferably 2,200 MPa or more.

The tensile strength may be 3,000 MPa or less from the viewpoint of securing hydrogen embrittlement resistance.

To obtain a tensile strength, from a flat part of the hot-stamping formed body (for example, in a case of a hat-shaped member, a top sheet part or a flat portion other than the top sheet part), a sub-size sheet-shaped test piece (parallel portion length: 32 mm, parallel portion width: 6.25 mm) according to the ASTM A370: 2022 standard is collected while maintaining the material thickness (in a case where a coating is provided, without excluding the coating) so that a tensile direction is parallel to a rolling direction, and a tensile test according to JIS Z 2241:2022 is performed with a gauge length of 25 mm and a crosshead separation rate of 1.0 mm/min at 20° C. The tensile strength is calculated as a value obtained by dividing a maximum test force by a cross-sectional area obtained by multiplying the material thickness (in a case where a coating is provided, the material thickness is a thickness excluding the measured coating thickness) by the parallel portion width of 6.25 mm.

### (Collision Resistance Characteristics)

In the hot-stamping formed body according to the present embodiment, as described above, excellent collision resistance characteristics (bendability and crack propagation resistance characteristics) are obtained by controlling the chemical composition and the microstructure.

Regarding bendability, as described below, for a bending test, a sample having a width of 30 mm in an orthogonal-to-rolling direction and a length of 60 mm in a rolling direction is collected from a flat part of the hot-stamping formed body (for example, in a case of a hat-shaped member, a top sheet part or a flat portion other than the top sheet part) while maintaining the material thickness of the hot-stamping formed body (in a case where a coating is provided, without excluding the coating), and the bending test is performed according to VDA238-100:2017 of VDA standard so that the direction of a bending ridge is in the orthogonal-to-rolling direction.

The product of a maximum bending angle obtained by the bending test and the tensile strength is preferably 80,000 (MPa-degree) or more. The product is more preferably 90,000 (MPa·degree) or more. The product is still more preferably 100,000 (MPa·degree) or more.

Crack propagation resistance characteristics are obtained by a test according to JIS Z 2242:2018 and JIS B 7755:2011. From a flat part of the hot-stamping formed body (for example, in a case of a hat-shaped member, a top sheet part or a flat portion other than the top sheet part), a test piece (a test piece having a shape according to JIS Z 2242:2018, except for a thickness, including a notch shape described later) having a size of 10 mm in width and 55 mm in length is collected while maintaining the material thickness of the hot-stamping formed body (in a case where a coating is provided, without excluding the coating) so that a rolling direction is in a length direction of the test piece, and a V-notch (notch angle: 45°, notch root radius: 0.25 mm, notch root width: 8 mm, notch position (center): a position 27.5 mm away from an end portion in the length direction of the test piece) having a depth of 2 mm is provided in the test piece. Then, three test pieces are overlapped, fixed with a screw, and subjected to an instrumented impact test. In a case where the sheet thickness is 2.00 mm or less, three test pieces are overlapped to perform the test, and in a case where the sheet thickness is more than 2.00 mm, one test piece is used without overlap to perform the test.

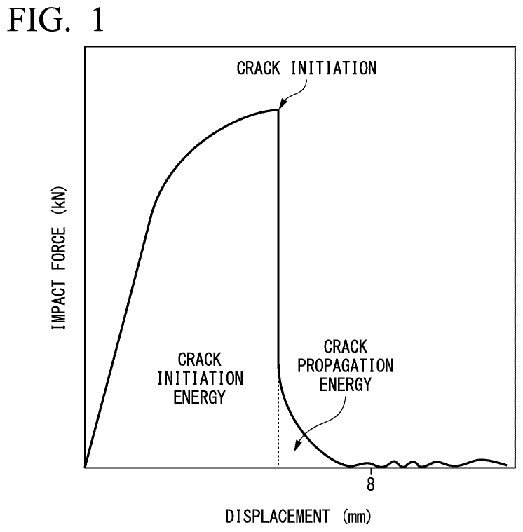

The instrumented impact test is performed at 20° C., and a time and an impact force from the start to the end of the test are measured. Next, a displacement is calculated from the product of a test speed of the instrumented impact test and the measured time. Since the fracture surface length of the Charpy test piece is 8 mm, the average value of the impact forces measured in the region where the displacement is 8 mm or more is set as a background. After subtracting the background from the impact forces at all the measurement points, an impact force-displacement curve is created. FIG. 1 is a diagram showing an example of the impact force-displacement curve obtained in the instrumented impact test. Since the impact force obtained in the instrumented Charpy test includes noise due to inherent vibration, smoothing processing is performed by performing 30-point moving average processing.

In the obtained impact force-displacement curve, an area under the curve from a displacement of 0 mm to a displacement of 8 mm was calculated, and the obtained value is determined as total impact energy. Next, an impact force (at a time when cracks are initiated in FIG. 1) at which a rapid decrease starts in the impact force-displacement curve is searched for, and a corresponding displacement (displacement at a time when cracks are initiated) is obtained. An area under the curve from the displacement of 0 mm to the displacement at a time when cracks are initiated is calculated and set as crack initiation energy. A value obtained by subtracting the crack initiation energy from the total impact energy is set as crack propagation energy. A ratio of the crack propagation energy to the total impact energy (crack propagation energy/(crack initiation energy+crack propagation energy)) is set as an index of crack propagation resistance characteristics. The rapid decrease in the impact force-displacement curve refers to a case where the amount of decrease in impact force per unit displacement is 50% or more of the maximum impact force measured.

As the crack propagation resistance characteristics, crack propagation energy/(crack initiation energy+crack propagation energy) is preferably 0.10 or more. Crack propagation energy/(crack initiation energy+crack propagation energy) is more preferably 0.20 or more, and still more preferably 0.30 or more.

### (Thickness)

In the hot-stamping formed body, the thickness of the flat portion (sheet thickness of the steel sheet as a material (excluding the coating)) is preferably 0.8 to 3.0 mm from the viewpoint of hardenability. The thickness may be 1.2 to 3.0 mm, 1.4 to 3.0 mm, or 1.5 to 3.0 mm.

### <Manufacturing Method>

The hot-stamping formed body according to the present embodiment can be manufactured by a manufacturing method including the following steps:
(I) A preliminary heat treatment step of heating a steel sheet having a predetermined chemical composition is heated to a temperature range of higher than 950° C. and 1,200° C. or lower so that an average heating rate is 2° C./s or more, holding the steel sheet for 1 second or longer and 1,200 seconds or shorter in the temperature range, and cooling the steel sheet after the holding so that an average cooling rate from the temperature range to a cooling stop temperature of 100° C. or lower is less than 15° C./s and an average cooling rate between 700° C. and 500° C. is less than 10° C./s; and
(II) A hot stamping step of performing hot-stamping (cooling with a die and punch at the same time) so that the steel sheet after the preliminary heat treatment step is heated to a temperature range of Ac3 to 1,100° C. at an average heating rate of 2° C./s or more and less than 50° C./s, the steel sheet is held in this temperature range for 10 seconds or longer and 600 seconds or shorter, forming is started in a temperature range of 650° C. or higher after the holding, and cooling is performed so that the average cooling rate to 250° C. is 10° C./s or more.

In addition, in a case where a coating is formed on the surface of the hot-stamping formed body, a coating step of forming the coating may be included between the preliminary heat treatment step and the hot stamping step.

Hereinafter, preferable conditions for each step will be described. Known conditions can be applied to conditions that are not described.

Here, Ac3 can be calculated by the following expression using the amount of each element.

$$Ac 3 ( °C . ) = 910 - 203 \times {C}^{0.5} + 66 \times Si - 25 \times Mn + 700 \times P - 11 \times Cr + 109 \times Al + 400 \times Ti - 15.2 \times Ni + 104 \times V + 31.5 \times Mo \qquad ( 1 )$$

In Expression (1), the element symbol indicates the amount of each element by mass %, and 0 is substituted in a case where the element is not contained.

### <Preliminary Heat Treatment Step>

In the preliminary heat treatment step, a steel sheet (including a case where a coating is provided on a surface) having a predetermined chemical composition is heated to a preliminary heat treatment temperature in a temperature range of higher than 950° C. and 1,200° C. or lower so that an average heating rate is 2° C./s or more, and the steel sheet is held in this temperature range for 1 second or longer and 1,200 seconds or shorter. After the holding, the steel sheet is cooled so that an average cooling rate from the temperature range (specifically, the temperature when the holding is completed) to a cooling stop temperature of 100° C. or lower is less than 15° C./s and an average cooling rate between 700° C. and 500° C. is less than 10° C./s.

In this step, the iron-based carbide that has been once dissolved is precipitated again during cooling and grown by Ostwald ripening to increase the distance between the iron-based carbides.

Some of the iron-based carbides generated in the preliminary heat treatment step may not be completely dissolved and remain in the hot stamping step to be subsequently performed. However, since a predetermined or longer average distance between the carbides can be secured, crack propagation resistance characteristics can be improved.

The preliminary heat treatment is performed before the hot stamping step, but is different from annealing that is performed on a cold-rolled steel sheet in the following points.

The normal annealing that is performed on a cold-rolled steel sheet is based on the idea that the microstructure of a base metal is homogenized, and by performing low-temperature heating without causing the prior austenite grain size to become coarse and by suppressing the coarsening of the iron-based carbide and dispersing it finely, stretch flangeability, elongation, and the like are secured. In contrast, the preliminary heat treatment in the present embodiment is different in that it is based on the idea that the iron-based carbide formed in the cold rolling annealing stage is re-dissolved by high-temperature heating, and is coarsened in the course of cooling by Ostwald ripening to control the inter-carbide distance and the crack propagation resistance characteristics after hot stamping.

In a case where the average heating rate to the preliminary heat treatment temperature is less than 2° C./s, the prior austenite grains coarsen, and collision resistance characteristics (bendability and crack propagation resistance characteristics) decrease. The upper limit of the average heating rate is not specified. However, since productivity is reduced from the viewpoint of unit consumption of fuel, the average heating rate is preferably 50° C./s or less, and more preferably 10° C./s or less.

In addition, in a case where the preliminary heat treatment temperature (holding temperature range) is 950° C. or lower, the iron-based carbide in the steel sheet is not dissolved, and the number density of the iron-based carbide having a circle equivalent diameter of more than 0.5 μm and the average distance between the iron-based carbides after the hot stamping step do not fall within the desired ranges. In this case, collision resistance characteristics (bendability and crack propagation resistance characteristics) decrease.

In a case where the preliminary heat treatment temperature is higher than 1,200° C., the prior austenite grains coarsen. In this case, collision resistance characteristics (bendability and crack propagation resistance characteristics) decrease.

In a case where the holding time in the above-described temperature range is shorter than 1 second, the iron-based carbide in the steel sheet is not dissolved, and the number density of the iron-based carbide having a circle equivalent diameter of more than 0.5 μm and the average distance between the iron-based carbides after the hot stamping step do not fall within the desired ranges. In a case where the holding time is longer than 1,200 seconds, the prior austenite grains coarsen. In this case, collision resistance characteristics (bendability and crack propagation resistance characteristics) decrease.

In a case where the average cooling rate from the holding temperature to the cooling stop temperature of 100° C. or lower is 15° C./s or more, Ostwald ripening of the iron-based carbide generated during cooling is not sufficient, and the average distance between the iron-based carbides having a circle equivalent diameter of more than 0.5 μm after the hot stamping step does not fall within a desired range. The lower limit of the average cooling rate from the holding temperature to the cooling stop temperature of 100° C. or lower is not particularly specified. However, from the viewpoint of productivity, the average cooling rate to 100° C. or lower is preferably 2° C./s or more, and more preferably 5° C./s or more.

The Ostwald ripening is particularly affected by a temperature range of 700° C. to 500° C. Therefore, even in a case where the average cooling rate from the holding temperature to the cooling stop temperature of 100° C. or lower is less than 15° C./s, in a case where the average cooling rate between 700° C. and 500° C. is 10° C./s or more,

Ostwald ripening of the iron-based carbide generated during cooling is not sufficient, and the average distance between the iron-based carbides having a circle equivalent diameter of more than 0.5 μm after the hot stamping step does not fall within a desired range. Therefore, it is necessary to satisfy both of the cooling rates. The lower limit of the average cooling rate between 700° C. and 500° C. is not particularly specified. However, from the viewpoint of productivity, the average cooling rate between 700° C. and 500° C. is preferably 1° C./s or more, and more preferably 4° C./s or more.

In addition, in a case where hot stamping is performed without cooling to 100° C. or lower, untransformed austenite in which carbon is concentrated may remain, and thus in the course of heating for hot stamping, the untransformed austenite may be decomposed into an iron-based carbide during heating in the hot stamping step and the number density of the iron-based carbide having a circle equivalent diameter of more than 0.5 μm may excessively increase. Therefore, the cooling is performed to 100° C. or lower under the above-described conditions.

Since the chemical composition does not change in the preliminary heat treatment step and the subsequent hot stamping step, the chemical composition of the steel sheet to be subjected to the preliminary heat treatment step may be the same as that of the hot-stamping formed body to be finally obtained. In addition, the steel sheet may be any of a hot-rolled steel sheet, a cold-rolled steel sheet, or the like, and is not limited. In addition, the manufacturing method of the steel sheet is not limited, but the steel sheet is manufactured under conditions described below, for example.

The microstructure of the steel sheet to be subjected to the preliminary heat treatment step is not limited, but is preferably a microstructure including ferrite and pearlite from the viewpoint of workability. Bainite and retained austenite may be included as a remainder in the microstructure.

### <Coating Step>

In a case where a coating is formed on the surface, the coating step may be included after the preliminary heat treatment step and before the hot stamping step. In the coating step, a coating is formed on the surface of the steel sheet to provide a coated steel sheet. The coating method is not particularly limited, and a hot-dip coating method, an electro plating method, a vacuum vapor deposition method, a cladding method, a thermal spraying method, and the like can be used. A hot-dip coating method is the most popular in the industry.

Examples of the coating may include an Al-based coating containing Al and a Zn-based coating containing Zn.

In a case where Al-based coating is performed, the coating becomes an Fe—Al-based coating in the subsequent hot stamping step. In addition, in a case where Zn-based coating is performed, the coating becomes an Fe—Zn-based coating in the subsequent hot stamping step.

In a case where an Al-based coating is formed by hot-dip coating, in addition to Al, Fe is mixed in a hot-dip coating bath as an impurity in many cases. Furthermore, in addition to the above-described elements, Si, Mg, Ca, Sr, Ni, Cu, Mo, Mn, Cr, C, Nb, Ti, B, V, Sn, W, Sb, Zn, Co, In, Bi, Zr, Se, As, and misch metal may be contained in the hot-dip coating bath as long as 70 mass % or more of Al is contained.

In a case where hot-dip coating is performed, the steel sheet after the preliminary heat treatment step may be heated, and the hot-dip coating may be performed at a temperature near the hot-dip coating bath temperature (for example, 650° C. to 750° C. in a case of Al-based hot-dip coating and 400° C. to 500° C. in a case of Zn-based hot-dip coating).

Pretreatments and post-treatments of the coating are not particularly limited, and precoating, solvent coating, an alloying treatment, or the like can be performed. As an alloying treatment, for example, a heat treatment can be performed at 450° C. to 600° C. in a case of Zn-based plating, and at 650° C. to 750° C. in a case of Al-based plating.

### <Hot Stamping Step>

In the hot stamping step, the steel sheet after the preliminary heat treatment step or the coating step is heated to a heating temperature in the hot-stamping in a temperature range of Ac3 (° C.) or higher and 1,100° C. or lower at an average heating rate of 2° C./s or more and less than 50° C./s, and held in this temperature range for 10 seconds or longer and 600 seconds or shorter. After the holding, forming is started in a temperature range of 650° C. or higher, and hot-stamping (cooling with a die and punch at the same time) is performed so that an average cooling rate to 250° C. is 10° C./s or more.

In this step, the prior austenite grain size and the area ratios of the phases in the microstructure are controlled.

In a case where the average heating rate to the hot-stamping heating temperature is less than 2° C./s, the prior austenite grains coarsen. In a case where the average heating rate is 50° C./s or more, the amount of the undissolved iron-based carbide having a circle equivalent diameter of more than 0.5 μm increases, and the number density of the iron-based carbide having a circle equivalent diameter of more than 0.5 μm and the average distance between the iron-based carbides cannot be adjusted within the predetermined ranges.

In addition, in a case where the hot-stamping heating temperature (and subsequent holding temperature range) is lower than Ac3 (° C.), the ferrite area ratio increases in the microstructure at the ¼-depth position of the hot-stamping formed body, and a predetermined martensite area ratio cannot be obtained. In addition, the amount of the undissolved iron-based carbide increases, and the number density of the iron-based carbide having a circle equivalent diameter of more than 0.5 μm and the average distance between the iron-based carbides having a circle equivalent diameter of more than 0.5 μm do not fall within the desired ranges. In a case where the heating temperature is higher than 1,100° C., the prior austenite grains coarsen, and collision resistance characteristics (bendability and crack propagation resistance characteristics) decrease. Furthermore, from the viewpoint of suppressing a decrease in collision resistance characteristics (bendability and crack propagation resistance characteristics), the heating temperature is preferably 1,000° C. or lower. The heating temperature is more preferably 950° C. or lower.

In addition, in a case where the holding time is shorter than 10 seconds, the amount of the undissolved iron-based carbide having a circle equivalent diameter of more than 0.5 μm excessively increases, and the number density of the iron-based carbide having a circle equivalent diameter of more than 0.5 μm and the average distance between the iron-based carbides cannot be adjusted within the predetermined ranges. In a case where the holding time is longer than 600 seconds, the prior austenite grains coarsen.

In a case where a forming start temperature of hot stamping is lower than 650° C., the amount of ferrite increases, and a predetermined martensite area ratio cannot be satisfied in the hot-stamping formed body.

In a case where the average cooling rate to 250° C. is less than 10° C./s, the amount of at least one of ferrite, pearlite, and bainite increases during cooling, and a predetermined martensite area ratio cannot be satisfied in the hot-stamping formed body.

### [Preferable Manufacturing Method of Steel Sheet to be Subjected to Preliminary Heat Treatment Step]

The steel sheet to be subjected to the preliminary heat treatment step is obtained under manufacturing conditions including, for example, the following “heating step”, “hot rolling step”, and “coiling step”, and further including a “cold rolling step” and/or an “annealing step”.as necessary. In addition, in a case where a hot-stamping formed body having a coating is obtained, a “coating forming step” may be further performed to form a coating on the steel sheet to be subjected to the preliminary heat treatment step.

### “Heating Step”

In the heating step, steel such as a slab having a predetermined chemical composition is heated before being subjected to hot rolling. The heating temperature is preferably set to 1,100° C. or higher, and the holding time in this temperature range is preferably set to 20 minutes or longer. After the holding, hot rolling is performed.

The heating temperature is preferably set to 1,100° C. or higher, and the holding time is preferably set to 20 minutes or longer from the viewpoint of rolling load in the hot rolling step. More preferably, the heating temperature is 1,200° C. or higher, and the holding time is 25 minutes or longer. The heating temperature is preferably 1,350° C. or lower, and the holding time is preferably 120 minutes or shorter.

### “Hot Rolling Step”

The hot rolling step usually includes rough rolling, finish rolling, and coiling.

Of these, finish rolling is preferably performed in a temperature range in which a finish rolling temperature (completion temperature) is 800° C. or higher in view of the sheet shape. The finish rolling temperature is more preferably 830° C. or higher. The finish rolling temperature is preferably 1,050° C. or lower.

After the finish rolling, the steel sheet is coiled into a coil. Therefore, a hot-rolled steel sheet is obtained. The coiling temperature is preferably set to 750° C. or lower from the viewpoint of promoting removal of scales in the next pickling step. In addition, from the viewpoint of rolling force in the cold rolling step, the coiling temperature is preferably 600° C. or higher.

### [Cold Rolling Step]

The steel sheet to be subjected to the preliminary heat treatment step may be a hot-rolled steel sheet after the hot rolling step or may be a cold-rolled steel sheet obtained by performing cold rolling on the hot-rolled steel sheet.

In a case where the steel sheet is a cold-rolled steel sheet, the cold rolling may be performed with a normal cumulative rolling reduction, for example, a cumulative rolling reduction of 30% to 90%.

In a case where cold rolling is performed, before the cold rolling, a reheating treatment (hot-rolled sheet annealing) may be performed for softening on the hot-rolled steel sheet.

### [Annealing Step]

The cold-rolled steel sheet after the cold rolling may be annealed for homogenizing the steel microstructure.

Examples of the annealing conditions include conditions in which the steel sheet is heated to a temperature range of 750° C. to 900° C. (annealing temperature), held in this temperature range for 10 to 600 seconds, and then cooled to 500° C. or lower at an average cooling rate of 5° C./s or more. From the viewpoint of promoting the recrystallization of the steel microstructure, thereby homogenizing the steel microstructure, the annealing temperature is preferably 750° C. or higher, and the holding time in this temperature range is preferably 10 seconds or longer. In addition, from the viewpoint of productivity, the annealing temperature is preferably 900° C. or lower, and the holding time in this temperature range is preferably 600 seconds or shorter.

In a case where a decarburization index Dc of the hot-stamping formed body is set to 0.085 or more, a surface layer region (a certain range from the surface) of the steel sheet is preferably decarburized by controlling the annealing atmosphere in the annealing step. Preferably, the annealing atmosphere contains 2 to 20 volume % of hydrogen and a remainder of impurities such as nitrogen and oxygen, and is an H₂O-containing atmosphere with a dew point of −10° C. or higher and 20° C. or lower. In order to promote decarburization by increasing the oxygen potential in the atmosphere to increase the decarburization index, the hydrogen concentration may be set to 2 vol % or more and the dew point may be set to −10° C. or higher, preferably, the hydrogen concentration is 3 vol % or more and the dew point is 0° C. or higher, and more preferably, the hydrogen concentration is 4 vol % or more and the dew point is 5° C. or higher. From the viewpoint of suppressing condensation on the equipment and not impairing the productivity, the hydrogen concentration may be set to 20 vol % or less and the dew point may be set to 20° C. or lower, preferably, the hydrogen concentration is 15 vol % or less and the dew point is 15° C. or lower, and more preferably, the hydrogen concentration is 10 vol % or less and the dew point is 10° C. or lower. In addition, in order to promote the decarburization reaction and increase the decarburization index, the annealing temperature is preferably 780° C. or higher. The annealing temperature is preferably 790° C. or higher. In addition, the annealing temperature is preferably 890° C. or lower, and more preferably 880° C. or lower from the viewpoint of productivity. The holding time in this temperature range is preferably 20 seconds or longer, and more preferably 60 seconds or longer in order to promote the decarburization reaction and increase the decarburization index. From the viewpoint of productivity, the holding time in this temperature range is preferably 590 seconds or shorter. Furthermore, in a case where the ferrite area ratio in the surface layer portion of the hot-stamping formed body is set to more than 5.0%, in addition to the above-described annealing conditions, it is preferable to control the annealing temperature to 820° C. or higher and the holding time in this temperature range to 90 seconds or longer.

### EXAMPLES

Slabs (steel types 1 to 61) having chemical compositions shown in Tables 1-1 to 1-4 were prepared (the column for the total of Ta and the like in the tables indicates a total amount of one or more selected from Ta, Re, Os, Ir, Tc, Pb, Se, Bi, and Sn).

The slabs were subjected to a heating step, a hot rolling step, a cold rolling step, and an annealing step under conditions shown in Tables 2-1 to 2-4, and steel sheets of Test Nos. 1 to 113 were obtained. In the tables, “-” indicates that the corresponding step was not performed. In addition, the average cooling rate in the annealing step in Tables 2-1 to 2-4 is an average cooling rate to a cooling stop temperature of 500° C. or lower after holding.

The obtained steel sheets were subjected to a preliminary heat treatment step and a hot stamping step under conditions shown in Tables 2-5 to 2-12 to obtain hot-stamping formed bodies. In the hot stamping step, the steel sheet was formed into a hat shape using a die and punch.

In addition, in some examples, the steel sheets were subjected to a coating step before the hot stamping step. In the coating step, hot-dip Zn coating or hot-dip Al coating was performed to form a plating layer on a surface.

TABLE 1-1

| Steel | Chemical Composition (mass %) * Remainder of Fe and Impurities | | | | | | | | | | | | | | |
|---|---|---|---|---|---|---|---|---|---|---|---|---|---|---|---|
| Type | C | Si | Mn | P | S | N | O | Al | Mo | B | Ti | Nb | Cr | Co | Ni |
| 1 | 0.20 | 0.200 | 1.20 | 0.010 | 0.0030 | 0.0022 | 0.0018 | 0.0360 | 0.0200 | 0.0018 | 0.023 | | | | |
| 2 | 0.45 | 0.300 | 0.40 | 0.010 | 0.0003 | 0.0024 | 0.0020 | 0.0360 | 0.2800 | 0.0022 | 0.017 | | | | |
| 3 | 0.68 | 0.300 | 0.40 | 0.012 | 0.0002 | 0.0026 | 0.0014 | 0.0300 | 0.1500 | 0.0019 | 10.025 | | | | |
| 4 | 0.18 | 0.200 | 1.00 | 0.010 | 0.0020 | 0.0030 | 0.0019 | 0.0300 | 0.0100 | 0.0020 | 0.020 | | | | |
| 5 | 0.79 | 0.360 | 0.42 | 0.015 | 0.0003 | 0.0027 | 0.0016 | 0.0410 | 0.2200 | 0.0021 | 0.020 | | | | |
| 6 | 0.46 | 0.010 | 0.50 | 0.011 | 0.0003 | 0.0024 | 0.0017 | 0.0300 | 0.2000 | 0.0030 | 0.023 | | | | |
| 7 | 0.46 | 1.000 | 0.50 | 0.011 | 0.0008 | 0.0027 | 0.0019 | 0.0400 | 0.1000 | 0.0025 | 0.021 | | | | |
| 8 | 0.45 | 2.000 | 0.44 | 0.011 | 0.0004 | 0.0024 | 0.0015 | 0.0420 | 0.3000 | 0.0018 | 10.025 | | | | |
| 9 | 0.45 | 0.005 | 0.40 | 0.011 | 0.0003 | 0.0026 | 0.0017 | 0.0330 | 0.2800 | 0.0020 | 0.020 | | | | |
| 10 | 0.45 | 2.100 | 1.00 | 0.012 | 0.0005 | 0.0028 | 0.0016 | 0.0300 | 0.3100 | 0.0022 | 0.022 | | | | |
| 11 | 0.46 | 0.500 | 0.05 | 0.010 | 0.0007 | 0.0030 | 0.0015 | 0.0350 | 0.6000 | 0.0025 | 0.021 | | | | |
| 12 | 0.45 | 0.300 | 1.00 | 0.010 | 0.0004 | 0.0024 | 0.0018 | 0.0360 | 0.0500 | 0.0020 | 0.023 | | | | |
| 13 | 0.44 | 0.200 | 1.96 | 0.010 | 0.0005 | 0.0036 | 0.0017 | 0.0320 | 0.0100 | 0.0019 | 0.020 | | | | |
| 14 | 0.45 | 0.200 | 2.10 | 0.010 | 0.0004 | 0.0025 | 0.0017 | 0.0360 | 0.1000 | 0.0023 | 10.021 | | | | |
| 15 | 0.45 | 0.300 | 0.40 | 0.095 | 0.0003 | 0.0030 | 0.0017 | 0.0310 | 0.3000 | 0.0017 | 0.019 | | | | |
| 16 | 0.45 | 0.300 | 0.45 | 0.110 | 0.0005 | 0.0031 | 0.0020 | 0.0320 | 0.3100 | 0.0020 | 0.022 | | | | |
| 17 | 0.35 | 0.300 | 1.30 | 0.010 | 0.0100 | 0.0025 | 0.0014 | 0.0310 | 0.0300 | 0.0018 | 0.019 | | | | |
| 18 | 0.35 | 0.310 | 1.32 | 0.010 | 0.0150 | 0.0027 | 0.0016 | 0.0320 | 0.0300 | 0.0020 | 0.018 | | | | |
| 19 | 0.45 | 10.200 | 10.40 | 0.010 | 0.0003 | 0.0090 | 0.0018 | 0.0400 | 0.3000 | 0.0022 | 0.035 | | | | |
| 20 | 0.45 | 0.230 | 0.42 | 0.011 | 0.0007 | 0.0160 | 0.0015 | 0.0340 | 0.2900 | 0.0025 | 0.020 | | | | |
| 21 | 0.47 | 0.320 | 0.48 | 0.011 | 0.0003 | 0.0028 | 0.0017 | 0.0010 | 0.2800 | 0.0021 | 0.021 | | | | |
| 22 | 0.46 | 0.310 | 0.45 | 0.010 | 0.0004 | 0.0035 | 0.0020 | 0.2500 | 0.2900 | 0.0020 | 0.022 | | | | |
| 23 | 0.46 | 0.300 | 0.46 | 0.010 | 0.0005 | 0.0030 | 0.0016 | 0.5000 | 0.2900 | 0.0021 | 0.023 | | | | |
| 24 | 0.47 | 10.320 | 0.48 | 0.011 | 0.0003 | 0.0028 | 0.0017 | 0.0009 | 0.2900 | 0.0025 | 0.022 | | | | |
| 25 | 0.47 | 0.300 | 0.50 | 0.010 | 0.0007 | 0.0030 | 0.0015 | 0.5100 | 0.3000 | 0.0021 | 0.022 | | | | |
| 26 | 0.45 | 10.400 | 0.90 | 0.010 | 0.0003 | 0.0024 | 0.0014 | 0.0360 | 0.0010 | 0.0025 | 0.024 | | | | |
| 27 | 0.45 | 0.300 | 0.40 | 0.010 | 0.0005 | 0.0027 | 0.0020 | 0.0350 | 0.5100 | 0.0024 | 0.020 | | | | |
| 28 | 0.46 | 0.320 | 0.20 | 0.011 | 0.0005 | 0.0030 | 0.0018 | 0.0360 | 0.9500 | 0.0022 | 0.021 | | | | |
| 29 | 0.21 | 0.200 | 1.10 | 10.010 | 0.0020 | 0.0035 | 0.0014 | 0.0360 | 0.0005 | 0.0020 | 0.021 | | | | |
| 30 | 0.45 | 0.320 | 0.30 | 0.011 | 0.0005 | 0.0030 | 0.0019 | 0.0360 | 1.1000 | 0.0023 | 0.021 | | | | |

TABLE 1-2

| Steel | Chemical Composition (mass %) * Remainder of Fe and Impurities | | | | | | | | | | | | | | |
|---|---|---|---|---|---|---|---|---|---|---|---|---|---|---|---|
| Type | C | Si | Mn | P | S | N | O | Al | Mo | B | Ti | Nb | Cr | Co | Ni |
| 31 | 0.21 | 0.200 | 1.20 | 0.010 | \|0.0019 | 0.0038 | 0.0015 | 0.0310 | 0.1000 | 0.0006 | 0.025 | | | | |
| 32 | 0.45 | 0.300 | 0.40 | 0.010 | 0.0004 | 0.0024 | 0.0016 | 0.0360 | 0.2900 | 0.0050 | 0.020 | | | | |
| 33 | 0.45 | 0.300 | 0.40 | 0.010 | \|0.0003 | 0.0025 | 0.0016 | 0.0360 | 0.3000 | 0.0095 | 0.021 | | | | |
| 34 | 0.21 | 0.200 | 1.20 | 0.010 | 0.0019 | 0.0045 | 0.0015 | 0.0200 | 0.0300 | 0.0002 | 0.015 | | | | |
| 35 | 0.46 | 0.300 | 0.40 | 0.010 | 0.0006 | 0.0030 | 0.0017 | 0.0240 | 0.3000 | 0.0110 | 0.019 | | | | |
| 36 | 0.46 | 0.300 | 0.40 | 0.011 | 0.0004 | 0.0025 | 0.0016 | 0.0370 | 0.3000 | 0.0025 | 0.010 | | | | |
| 37 | 0.46 | 0.300 | 0.40 | 0.011 | 0.0005 | 0.0026 | 0.0016 | 0.0350 | 0.3000 | 0.0024 | 0.051 | | | | |
| 38 | 0.46 | 0.300 | 0.40 | 0.010 | 0.0003 | 0.0026 | 0.0015 | 0.0320 | 0.3000 | 0.0026 | 0.095 | | | | |
| 39 | 0.20 | 0.200 | 1.20 | 0.010 | 0.0020 | 0.0047 | 0.0017 | 0.0300 | 0.0100 | 0.0017 | 0.005 | | | | |
| 40 | 0.47 | 0.320 | 0.40 | 0.010 | 0.0007 | 0.0030 | 0.0016 | 0.0320 | 0.3000 | 0.0025 | 0.110 | | | | |
| 41 | 0.46 | 0.430 | 0.41 | 0.007 | 0.0004 | 0.0025 | 0.0017 | 0.0380 | 0.2500 | 0.0022 | 0.030 | 0.018 | | | |
| 42 | 0.46 | 0.430 | 0.40 | 0.011 | 0.0004 | 0.0026 | 0.0017 | 0.0370 | 0.2000 | 0.0023 | 0.027 | | 0.27 | | |
| 43 | 0.46 | 0.420 | 0.40 | 0.010 | 0.0005 | 0.0025 | 0.0017 | 0.0400 | 0.2000 | 0.0025 | 0.025 | | | 1.00 | |
| 44 | 0.45 | 0.300 | 0.40 | 0.010 | 0.0003 | 0.0030 | 0.0020 | 0.0350 | 0.1900 | 0.0022 | 0.019 | | | | 0.50 |
| 45 | 0.46 | 0.300 | 0.40 | 0.011 | 0.0004 | 0.0028 | 0.0015 | 0.0370 | 0.2000 | 0.0023 | 0.020 | | | | |
| 46 | 0.46 | 0.300 | 0.40 | 0.010 | 0.0005 | 0.0030 | 0.0020 | 0.0350 | 0.2000 | 0.0025 | 0.020 | | | | |
| 47 | 0.46 | 0.300 | 0.40 | 0.012 | 0.0004 | 0.0036 | 0.0015 | 0.0360 | 0.2000 | 0.0024 | 0.021 | | | | |
| 48 | 0.46 | 0.290 | 0.40 | 0.011 | 0.0005 | 0.0040 | 0.0150 | 0.0380 | 0.2000 | 0.0025 | 0.022 | | | | |
| 49 | 0.46 | 0.300 | 0.40 | 0.010 | 0.0004 | 0.0038 | 0.0014 | 0.0360 | 0.2000 | 0.0023 | 0.021 | | | | |
| 50 | 0.46 | 0.300 | 0.40 | 0.012 | 0.0006 | 0.0039 | 0.0019 | 0.0390 | 0.2000 | 0.0025 | 0.021 | | | | |
| 51 | 0.46 | 0.300 | 0.40 | 0.011 | 0.0006 | 0.0037 | 0.0018 | 0.0360 | 0.2000 | 0.0024 | 0.022 | | | | |
| 52 | 0.46 | 0.300 | 0.40 | 0.010 | 0.0005 | 0.0031 | 0.0018 | 0.0340 | 0.2000 | 0.0026 | 0.020 | | | | |
| 53 | 0.46 | 0.300 | 0.41 | 0.010 | 0.0003 | 0.0025 | 0.0015 | 0.0360 | 0.2100 | 0.0021 | 0.019 | | | | |
| 54 | 0.46 | 0.300 | 0.40 | 0.010 | 0.0004 | 0.0034 | 0.0016 | 0.0340 | 0.2000 | 0.0025 | 0.022 | | | | |
| 55 | 0.46 | 0.300 | 0.40 | 0.011 | 0.0003 | 0.0036 | 0.0019 | 0.0330 | 0.2000 | 0.0024 | 0.021 | | | | |
| 56 | 0.46 | 0.300 | 0.40 | 0.012 | 0.0005 | 0.0033 | 0.0016 | 0.0380 | 0.2000 | 0.0020 | 0.022 | | | | |
| 57 | 0.46 | 0.290 | 0.40 | 0.011 | 0.0007 | 0.0041 | 0.0220 | 0.0410 | 0.2000 | 0.0024 | 0.023 | | | | |
| 58 | 0.46 | 0.440 | 0.40 | 0.008 | 0.0003 | 0.0027 | 0.0018 | 0.0390 | 0.6000 | 0.0022 | 0.030 | 0.050 | | | |
| 59 | 0.30 | 0.230 | 1.66 | 0.010 | 0.0006 | 0.0025 | 0.0017 | 0.0300 | 0.0100 | 0.0017 | 0.020 | 0.080 | 0.18 | | |
| 60 | 0.34 | 0.220 | 1.30 | 0.007 | 0.0004 | 0.0023 | 0.0019 | 0.0430 | 0.0100 | 0.0018 | 0.028 | 0.049 | 0.20 | | |
| 61 | 0.46 | 0.400 | 0.39 | 0.012 | 0.0005 | 0.0026 | 0.0017 | 0.0370 | 0.2000 | 0.0023 | 0.029 | 0.030 | 0.50 | | |

TABLE 1-3

| | Chemical Composition (mass %) * Remainder of Fe and Impurities | | | | | | | | | | |
|---|---|---|---|---|---|---|---|---|---|---|---|
| | | | | | | | | | | Total of | |
| Steel | | | | | | | | | | Ta and | Ac3 |
| Type | Cu | V | W | Ca | Mg | REM | Sb | Zr | As | the like | (° C.) |
| 1 | | | | | | | | | | | 823 |
| 2 | | | | | | | | | | | 810 |
| 3 | | | | | | | | | | | 779 |
| 4 | | | | | | | | | | | 831 |
| 5 | | | | | | | | | | | 773 |
| 6 | | | | | | | | | | | 787 |
| 7 | | | | | | | | | | | 849 |
| 8 | | | | | | | | | | | 927 |
| 9 | | | | | | | | | | | 792 |
| 10 | | | | | | | | | | | 918 |
| 11 | | | | | | | | | | | 842 |
| 12 | | | | | | | | | | | 790 |
| 13 | | | | | | | | | | | 758 |
| 14 | | | | | | | | | | | 757 |
| 15 | | | | | | | | | | | 871 |
| 16 | | | | | | | | | | | 881 |
| 17 | | | | | | | | | | | 796 |
| 18 | | | | | | | | | | | 796 |
| 19 | | | | | | | | | | | 812 |
| 20 | | | | | | | | | | | 807 |
| 21 | | | | | | | | | | | 805 |
| 22 | | | | | | | | | | | 834 |
| 23 | | | | | | | | | | | 860 |
| 24 | | | | | | | | | | | 806 |
| 25 | | | | | | | | | | | 859 |
| 26 | | | | | | | | | | | 798 |
| 27 | | | | | | | | | | | 819 |
| 28 | | | | | | | | | | | 838 |
| 29 | | | | | | | | | | | 822 |
| 30 | | | | | | | | | | | 842 |

TABLE 1-4

| | Chemical Composition (mass %) * Remainder of Fe and Impurities | | | | | | | | | | |
|---|---|---|---|---|---|---|---|---|---|---|---|
| | | | | | | | | | | Total of | |
| Steel | | | | | | | | | | Ta and | Ac3 |
| Type | Cu | V | W | Ca | Mg | REM | Sb | Zr | As | the like | (° C.) |
| 31 | | | | | | | | | | | 824 |
| 32 | | | | | | | | | | | 812 |
| 33 | | | | | | | | | | | 812 |
| 34 | | | | | | | | | | | 816 |
| 35 | | | | | | | | | | | 809 |
| 36 | | | | | | | | | | | 807 |
| 37 | | | | | | | | | | | 823 |
| 38 | | | | | | | | | | | 840 |
| 39 | | | | | | | | | | | 815 |
| 40 | | | | | | | | | | | 846 |
| 41 | | | | | | | | | | | 819 |
| 42 | | | | | | | | | | | 817 |
| 43 | | | | | | | | | | | 818 |
| 44 | | | | | | | | | | | 800 |
| 45 | 0.20 | | | | | | | | | | 808 |
| 46 | | 0.300 | | | | | | | | | 838 |
| 47 | | | 0.30 | | | | | | | | 809 |
| 48 | | | | | | | | | | | 808 |
| 49 | | | | 0.0020 | | | | | | | 808 |
| 50 | | | | | 0.0090 | | | | | | 809 |
| 51 | | | | | | 0.0090 | | | | | 809 |
| 52 | | | | | | | 0.020 | | | | 807 |
| 53 | | | | | | | | 0.010 | | | 807 |
| 54 | | | | | | | | | 0.010 | | 808 |
| 55 | | | | | | | | | | 0.010 | 808 |
| 56 | | | | | | | | | | 0.100 | 810 |
| 57 | | | | | | | | | | | 809 |
| 58 | | 0.050 | | | | | | | | | 837 |
| 59 | | | | | | | | | | | 789 |
| 60 | | | | | | | | | | | 793 |
| 61 | | | | | | | | | | | 814 |

TABLE 2-1

| | Manufacturing Method | | | | | | | | | | |
|---|---|---|---|---|---|---|---|---|---|---|---|
| | | | | | | Cold | | | | | |
| | | | | | | Rolling | | | | | |
| | | | | Hot Rolling Step | | Step | Annealing Step | | | | |
| | | Heating Step | | Finish | | Cumulative | | | | | Average |
| | | Heating | Holding | Rolling | Winding | Rolling | Hydrogen | Dew | Annealing | Holding | Cooling |
| Test | Steel | Temperature | Time | Temperature | Temperature | Reduction | Concentration | Point | Temperature | Time | Rate |
| No. | Type | (° C.) | (min) | (° C.) | (° C.) | (%) | (vol %) | (° C.) | (° C.) | (s) | (° C./s) |
| 1 | 1 | 1200 | 60 | 900 | 640 | 47 | 2 | −20 | 780 | 90 | 10 |
| 2 | 2 | 1230 | 62 | 910 | 635 | 47 | 4 | 0 | 810 | 90 | 7 |
| 3 | 3 | 1290 | 70 | 895 | 656 | 47 | 6 | 10 | 830 | 240 | 7 |
| 4 | 4 | 1200 | 60 | 905 | 620 | 47 | 2 | −20 | 770 | 95 | 7 |
| 5 | 5 | 1280 | 70 | 899 | 660 | 47 | 6 | 10 | 800 | 90 | 8 |
| 6 | 6 | 1240 | 65 | 900 | 640 | 47 | 3 | −15 | 780 | 60 | 7 |
| 7 | 7 | 1250 | 70 | 950 | 610 | 47 | 6 | 10 | 860 | 60 | 7 |
| 8 | 8 | 1250 | 70 | 960 | 620 | 47 | 6 | 10 | 860 | 60 | 7 |
| 9 | 9 | 1200 | 60 | 900 | 630 | 47 | 3 | −15 | 780 | 60 | 7 |
| 10 | 10 | 1200 | 60 | 900 | 630 | 47 | 6 | 10 | 855 | 60 | 7 |
| 11 | 11 | 1250 | 60 | 950 | 640 | 47 | 4 | 0 | 780 | 100 | 7 |
| 12 | 12 | 1250 | 65 | 900 | 645 | 47 | 2 | −25 | 770 | 90 | 7 |
| 13 | 13 | 1250 | 60 | 900 | 634 | 47 | 2 | −20 | 780 | 90 | 7 |
| 14 | 14 | 1250 | 60 | 910 | 636 | 47 | 2 | −20 | 780 | 90 | 7 |
| 15 | 15 | 1250 | 60 | 903 | 640 | 47 | 5 | 5 | 800 | 90 | 7 |
| 16 | 16 | 1250 | 50 | 912 | 645 | 47 | 5 | 5 | 800 | 90 | 7 |
| 17 | 17 | 1240 | 60 | 910 | 643 | 47 | — | — | — | — | — |
| 18 | 18 | 1240 | 60 | 915 | 637 | 47 | — | — | — | — | — |
| 19 | 19 | 1250 | 50 | 900 | 632 | 47 | — | — | — | — | — |
| 20 | 20 | 1250 | 60 | 905 | 641 | 47 | — | — | — | — | — |
| 21 | 21 | 1250 | 60 | 900 | 639 | 47 | 4 | 0 | 800 | 60 | 7 |
| 22 | 22 | 1250 | 60 | 905 | 640 | 47 | 4 | 0 | 800 | 60 | 7 |
| 23 | 23 | 1250 | 60 | 904 | 641 | 47 | 4 | 0 | 800 | 60 | 7 |
| 24 | 24 | 1250 | 60 | 903 | 644 | 47 | 4 | 0 | 800 | 60 | 8 |
| 25 | 25 | 1250 | 60 | 920 | 650 | 47 | 4 | 0 | 800 | 60 | 7 |
| 26 | 26 | 1240 | 60 | 900 | 630 | 47 | — | — | — | — | — |
| 27 | 27 | 1250 | 60 | 930 | 632 | 47 | 4 | 0 | 800 | 60 | 7 |
| 28 | 28 | 1240 | 60 | 980 | 653 | 47 | 4 | 0 | 800 | 60 | 7 |

TABLE 2-2

| | Manufacturing Method | | | | | | | | | | |
|---|---|---|---|---|---|---|---|---|---|---|---|
| | | | | | | Cold | | | | | |
| | | | | | | Rolling | | | | | |
| | | | | Hot Rolling Step | | Step | Annealing Step | | | | |
| | | Heating Step | | Finish | | Cumulative | | | | | Average |
| | | Heating | Holding | Rolling | Winding | Rolling | Hydrogen | Dew | Annealing | Holding | Cooling |
| Test | Steel | Temperature | Time | Temperature | Temperature | Reduction | Concentration | Point | Temperature | Time | Rate |
| No. | Type | (° C.) | (min) | (° C.) | (° C.) | (%) | (vol %) | (° C.) | (° C.) | (s) | (° C./s) |
| 29 | 29 | 1250 | 60 | 930 | 634 | 47 | 2 | −20 | 780 | 90 | 9 |
| 30 | 30 | 1250 | 60 | 980 | 652 | 47 | — | — | — | — | — |
| 31 | 31 | 1200 | 60 | 900 | 640 | 47 | — | — | — | — | — |
| 32 | 32 | 1200 | 60 | 900 | 640 | 47 | 4 | 0 | 800 | 90 | 7 |
| 33 | 33 | 1200 | 60 | 900 | 640 | 47 | 4 | 0 | 800 | 90 | 7 |
| 34 | 34 | 1200 | 60 | 900 | 640 | 47 | — | — | — | — | — |
| 35 | 35 | 1200 | 60 | 900 | 640 | 47 | 6 | 10 | 800 | 60 | 7 |
| 36 | 36 | 1250 | 60 | 920 | 638 | 47 | 5 | 5 | 800 | 90 | 10 |
| 37 | 37 | 1250 | 60 | 920 | 632 | 47 | 5 | 5 | 800 | 90 | 10 |
| 38 | 38 | 1250 | 60 | 920 | 640 | 47 | 5 | 5 | 800 | 90 | 10 |
| 39 | 39 | 1200 | 60 | 900 | 640 | 47 | — | — | — | — | — |
| 40 | 40 | 1250 | 60 | 920 | 645 | 47 | — | — | — | — | — |
| 41 | 41 | 1250 | 60 | 920 | 630 | 47 | 5 | 5 | 800 | 90 | 7 |
| 42 | 42 | 1250 | 60 | 910 | 635 | 47 | 5 | 6 | 800 | 90 | 7 |
| 43 | 43 | 1250 | 60 | 920 | 635 | 47 | 5 | 6 | 800 | 90 | 7 |
| 44 | 44 | 1250 | 60 | 910 | 634 | 47 | 5 | 7 | 800 | 90 | 7 |
| 45 | 45 | 1250 | 60 | 915 | 631 | 47 | 5 | 6 | 800 | 90 | 7 |
| 46 | 46 | 1250 | 60 | 917 | 630 | 47 | 5 | 6 | 800 | 90 | 7 |
| 47 | 47 | 1250 | 60 | 918 | 637 | 47 | 5 | 6 | 800 | 90 | 7 |
| 48 | 48 | 1250 | 60 | 920 | 633 | 47 | 5 | 5 | 800 | 90 | 7 |
| 49 | 49 | 1250 | 60 | 920 | 633 | 47 | 5 | 6 | 800 | 90 | 7 |
| 50 | 50 | 1250 | 60 | 920 | 633 | 47 | 5 | 5 | 800 | 90 | 7 |
| 51 | 51 | 1250 | 60 | 918 | 640 | 47 | 5 | 6 | 800 | 90 | 7 |
| 52 | 52 | 1250 | 60 | 920 | 635 | 47 | 5 | 6 | 800 | 90 | 7 |
| 53 | 53 | 1250 | 60 | 919 | 637 | 47 | 5 | 6 | 800 | 90 | 7 |
| 54 | 54 | 1250 | 60 | 920 | 632 | 47 | 5 | 6 | 800 | 90 | 7 |
| 55 | 55 | 1250 | 60 | 918 | 635 | 47 | 5 | 5 | 800 | 90 | 7 |
| 56 | 56 | 1250 | 60 | 920 | 639 | 47 | 5 | 5 | 800 | 90 | 7 |

TABLE 2-3

| | Manufacturing Method | | | | | | | | | | |
|---|---|---|---|---|---|---|---|---|---|---|---|
| | | | | | | Cold | | | | | |
| | | | | | | Rolling | | | | | |
| | | | | Hot Rolling Step | | Step | Annealing Step | | | | |
| | | Heating Step | | Finish | | Cumulative | | | | | Average |
| | | Heating | Holding | Rolling | Winding | Rolling | Hydrogen | Dew | Annealing | Holding | Cooling |
| Test | Steel | Temperature | Time | Temperature | Temperature | Reduction | Concentration | Point | Temperature | Time | Rate |
| No. | Type | (° C.) | (min) | (° C.) | (° C.) | (%) | (vol %) | (° C.) | (° C.) | (s) | (° C./s) |
| 57 | 41 | 1100 | 60 | 918 | 629 | 47 | 5 | 5 | 800 | 90 | 6 |
| 58 | 41 | 1350 | 60 | 920 | 640 | 47 | 5 | 5 | 800 | 90 | 6 |
| 59 | 41 | 1250 | 20 | 917 | 643 | 47 | 5 | 6 | 800 | 90 | 6 |
| 60 | 41 | 1250 | 120 | 923 | 643 | 47 | 5 | 6 | 800 | 90 | 6 |
| 61 | 41 | 1200 | 60 | 895 | 645 | 47 | 5 | 6 | 800 | 90 | 6 |
| 62 | 41 | 1249 | 60 | 1045 | 623 | 47 | 5 | 5 | 800 | 90 | 6 |
| 63 | 41 | 1255 | 60 | 918 | 600 | 47 | 5 | 6 | 800 | 90 | 6 |
| 64 | 41 | 1249 | 60 | 918 | 749 | 47 | 5 | 6 | 800 | 90 | 6 |
| 65 | 41 | 1254 | 60 | 925 | 650 | — | — | — | — | — | — |
| 66 | 41 | 1255 | 60 | 926 | 640 | 30 | 5 | 7 | 800 | 90 | 6 |
| 67 | 41 | 1247 | 60 | 917 | 667 | 50 | 5 | 7 | 800 | 90 | 6 |
| 68 | 41 | 1251 | 60 | 918 | 625 | 47 | 5 | 5 | 750 | 90 | 7 |
| 69 | 41 | 1249 | 60 | 925 | 627 | 47 | 5 | 6 | 880 | 90 | 6 |
| 70 | 41 | 1249 | 60 | 921 | 625 | 47 | 5 | 7 | 800 | 20 | 7 |
| 71 | 41 | 1252 | 60 | 921 | 635 | 47 | 5 | 7 | 820 | 590 | 6 |
| 72 | 41 | 1250 | 60 | 920 | 631 | 47 | 2 | −10 | 780 | 90 | 7 |
| 73 | 41 | 1251 | 60 | 921 | 634 | 47 | 10 | 20 | 800 | 90 | 6 |
| 74 | 41 | 1250 | 60 | 924 | 622 | 47 | 5 | 7 | 800 | 90 | 7 |
| 75 | 41 | 1248 | 60 | 920 | 646 | 47 | 5 | 7 | 800 | 90 | 7 |
| 76 | 41 | 1246 | 60 | 916 | 620 | 47 | 5 | 6 | 800 | 90 | 7 |
| 77 | 41 | 1247 | 60 | 921 | 637 | 47 | 5 | 5 | 800 | 90 | 7 |
| 78 | 41 | 1255 | 60 | 919 | 647 | 47 | 5 | 6 | 800 | 90 | 6 |
| 79 | 41 | 1246 | 60 | 925 | 637 | 47 | 5 | 5 | 800 | 90 | 6 |
| 80 | 41 | 1250 | 60 | 919 | 646 | 47 | 5 | 6 | 800 | 90 | 6 |
| 81 | 41 | 1252 | 60 | 924 | 624 | 47 | 5 | 6 | 800 | 90 | 7 |
| 82 | 41 | 1255 | 60 | 918 | 636 | 47 | 5 | 6 | 800 | 90 | 7 |
| 83 | 41 | 1251 | 60 | 916 | 648 | 47 | 5 | 6 | 800 | 90 | 6 |
| 84 | 41 | 1253 | 60 | 923 | 629 | 47 | 5 | 7 | 800 | 90 | 6 |

TABLE 2-4

| | Manufacturing Method | | | | | | | | | | |
|---|---|---|---|---|---|---|---|---|---|---|---|
| | | | | | | Cold | | | | | |
| | | | | | | Rolling | | | | | |
| | | | | Hot Rolling Step | | Step | Annealing Step | | | | |
| | | Heating Step | | Finish | | Cumulative | | | | | Average |
| | | Heating | Holding | Rolling | Winding | Rolling | Hydrogen | Dew | Annealing | Holding | Cooling |
| Test | Steel | Temperature | Time | Temperature | Temperature | Reduction | Concentration | Point | Temperature | Time | Rate |
| No. | Type | (° C.) | (min) | (° C.) | (° C.) | (%) | (vol %) | (° C.) | (° C.) | (s) | (° C./s) |
| 85 | 41 | 1253 | 60 | 920 | 634 | 47 | 5 | 6 | 800 | 90 | 6 |
| 86 | 41 | 1248 | 60 | 920 | 650 | 47 | 5 | 7 | 800 | 90 | 6 |
| 87 | 41 | 1245 | 60 | 917 | 640 | 47 | 5 | 7 | 800 | 90 | 6 |
| 88 | 41 | 1253 | 60 | 918 | 646 | 47 | 5 | 7 | 800 | 90 | 6 |
| 89 | 41 | 1255 | 60 | 921 | 643 | 47 | 5 | 7 | 800 | 90 | 6 |
| 90 | 41 | 1245 | 60 | 915 | 639 | 47 | 5 | 6 | 800 | 90 | 7 |
| 91 | 41 | 1251 | 60 | 924 | 638 | 47 | 5 | 7 | 800 | 90 | 7 |
| 92 | 41 | 1248 | 60 | 916 | 631 | 47 | 5 | 5 | 800 | 90 | 7 |
| 93 | 41 | 1245 | 60 | 920 | 639 | 47 | 5 | 5 | 800 | 90 | 6 |
| 94 | 41 | 1246 | 60 | 922 | 625 | 47 | 5 | 7 | 800 | 90 | 6 |
| 95 | 41 | 1246 | 60 | 919 | 642 | 47 | 5 | 6 | 800 | 90 | 6 |
| 96 | 41 | 1252 | 60 | 925 | 632 | 47 | 5 | 7 | 800 | 90 | 6 |
| 97 | 41 | 1250 | 60 | 925 | 644 | 47 | 5 | 7 | 800 | 90 | 6 |
| 98 | 41 | 1251 | 60 | 923 | 626 | 47 | 5 | 7 | 800 | 90 | 6 |
| 99 | 41 | 1246 | 60 | 923 | 647 | 47 | 5 | 7 | 800 | 90 | 7 |
| 100 | 41 | 1255 | 60 | 915 | 649 | 47 | 5 | 7 | 800 | 90 | 7 |
| 101 | 41 | 1250 | 60 | 916 | 628 | 47 | 5 | 6 | 800 | 90 | 7 |
| 102 | 41 | 1249 | 60 | 916 | 626 | 47 | 5 | 5 | 800 | 90 | 6 |
| 103 | 41 | 1251 | 60 | 920 | 650 | 47 | 5 | 5 | 820 | 90 | 6 |
| 104 | 57 | 1250 | 60 | 920 | 635 | 47 | 5 | 5 | 800 | 90 | 7 |
| 105 | 58 | 1250 | 60 | 920 | 631 | 47 | 5 | 5 | 800 | 90 | 7 |
| 106 | 58 | 1250 | 60 | 920 | 630 | 47 | 5 | 5 | 800 | 90 | 7 |
| 107 | 58 | 1250 | 60 | 920 | 630 | 47 | 5 | 5 | 780 | 160 | 7 |
| 108 | 41 | 1250 | 60 | 920 | 629 | 47 | 5 | 5 | 800 | 90 | 7 |
| 109 | 1 | 1200 | 60 | 900 | 640 | 47 | 8 | 20 | 830 | 300 | 10 |
| 110 | 41 | 1250 | 60 | 920 | 634 | 47 | 2 | −35 | 760 | 30 | 7 |
| 111 | 59 | 1250 | 60 | 915 | 620 | 47 | — | — | — | — | — |
| 112 | 60 | 1248 | 60 | 910 | 624 | 47 | — | — | — | — | — |
| 113 | 61 | 1248 | 60 | 920 | 603 | 47 | 5 | 6 | 800 | 90 | 7 |

TABLE 2-5

| | Manufacturing Method | | | | | |
|---|---|---|---|---|---|---|
| | Preliminary Heat Treatment Step | | | | | |
| | | | | Average | Average | |
| | | | | Cooling Rate | Cooling | |
| | | Preliminary | | from Preliminary | Rate | |
| | Average | Heat | | Heat Treatment | Between | |
| | Heating | Treatment | Holding | Temperature to | 700° C. | |
| Test | rate | Temperature | Time | 100° C. or Lower | and 500° C. | Coating Step |
| No. | (° C./s) | (° C.) | (s) | (° C./s) | (° C./s) | Coating Type |
| 1 | 5 | 980 | 95 | 10 | 5 | Zn-based |
| | | | | | | Hot-dip |
| | | | | | | Coating |
| 2 | 4 | 1000 | 90 | 10 | 4 | |
| 3 | 4 | 1000 | 100 | 8 | 5 | |
| 4 | 4 | 1000 | 90 | 9 | 5 | |
| 5 | 4 | 1000 | 100 | 12 | 8 | |
| 6 | 4 | 1005 | 91 | 10 | 5 | |
| 7 | 5 | 1000 | 95 | 8 | 5 | |
| 8 | 5 | 1000 | 94 | 7 | 4 | |
| 9 | 5 | 980 | 100 | 10 | 5 | |
| 10 | 5 | 1000 | 90 | 7 | 5 | |
| 11 | 4 | 1000 | 90 | 8 | 4 | Al-based |
| | | | | | | Hot-dip |
| | | | | | | Coating |
| 12 | 5 | 1000 | 60 | 9 | 6 | |
| 13 | 4 | 1000 | 200 | 8 | 6 | |
| 14 | 5 | 1000 | 200 | 10 | 8 | |
| 15 | 5 | 990 | 60 | 8 | 4 | |
| 16 | 5 | 990 | 65 | 8 | 4 | |
| 17 | 5 | 1000 | 60 | 10 | 5 | |
| 18 | 5 | 1000 | 60 | 10 | 5 | |
| 19 | 5 | 1000 | 60 | 10 | 5 | |
| 20 | 5 | 1000 | 60 | 10 | 5 | |
| 21 | 5 | 1000 | 60 | 8 | 4 | |
| 22 | 5 | 1000 | 60 | 8 | 4 | Zn-based |
| | | | | | | Hot-dip |
| | | | | | | Coating |
| 23 | 5 | 1000 | 60 | 8 | 4 | |
| 24 | 5 | 1000 | 60 | 8 | 4 | |
| 25 | 5 | 1000 | 60 | 8 | 4 | |
| 26 | 5 | 1000 | 60 | 8 | 5 | |
| 27 | 5 | 1000 | 60 | 8 | 5 | |
| 28 | 5 | 1000 | 60 | 8 | 5 | |

TABLE 2-6

| | Manufacturing Method | | | | | |
|---|---|---|---|---|---|---|
| | Preliminary Heat Treatment Step | | | | | |
| | | | | Average | Average | |
| | | | | Cooling Rate | Cooling | |
| | | Preliminary | | from Preliminary | Rate | |
| | Average | Heat | | Heat Treatment | Between | |
| | Heating | Treatment | Holding | Temperature to | 700° C. | |
| Test | rate | Temperature | Time | 100° C. or Lower | and 500° C. | Coating Step |
| No. | (° C./s) | (° C.) | (s) | (° C./s) | (° C./s) | Coating Type |
| 29 | 5 | 980 | 96 | 10 | 5 | |
| 30 | 5 | 1000 | 60 | 8 | 5 | |
| 31 | 5 | 970 | 90 | 10 | 5 | |
| 32 | 5 | 1000 | 60 | 8 | 5 | |
| 33 | 5 | 1000 | 60 | 8 | 5 | Al-based |
| | | | | | | Hot-dip |
| | | | | | | Coating |
| 34 | 5 | 970 | 90 | 10 | 5 | |
| 35 | 5 | 1000 | 60 | 8 | 5 | |
| 36 | 5 | 1000 | 60 | 10 | 5 | |
| 37 | 5 | 1000 | 60 | 10 | 5 | |
| 38 | 5 | 1000 | 60 | 9 | 4 | |
| 39 | 5 | 1000 | 60 | 10 | 5 | |
| 40 | 5 | 1000 | 60 | 10 | 5 | |
| 41 | 5 | 1000 | 60 | 10 | 6 | |
| 42 | 5 | 1000 | 60 | 10 | 5 | |
| 43 | 5 | 1000 | 60 | 9 | 7 | |
| 44 | 5 | 1000 | 60 | 9 | 7 | |
| 45 | 5 | 1000 | 60 | 9 | 4 | |
| 46 | 5 | 1000 | 60 | 9 | 6 | |
| 47 | 5 | 1000 | 60 | 9 | 7 | |
| 48 | 5 | 1000 | 60 | 8 | 7 | |
| 49 | 5 | 1000 | 60 | 10 | 5 | |
| 50 | 5 | 1000 | 60 | 8 | 4 | |
| 51 | 5 | 1000 | 60 | 9 | 4 | |
| 52 | 5 | 1000 | 60 | 10 | 4 | |
| 53 | 5 | 1000 | 60 | 10 | 5 | |
| 54 | 5 | 1000 | 60 | 9 | 6 | |
| 55 | 5 | 1000 | 60 | 9 | 5 | |
| 56 | 5 | 1000 | 60 | 10 | 6 | |

TABLE 2-7

| | Manufacturing Method | | | | | |
|---|---|---|---|---|---|---|
| | Preliminary Heat Treatment Step | | | | | |
| | | | | Average | Average | |
| | | | | Cooling Rate | Cooling | |
| | | Preliminary | | from Preliminary | Rate | |
| | Average | Heat | | Heat Treatment | Between | |
| | Heating | Treatment | Holding | Temperature to | 700° C. | |
| Test | rate | Temperature | Time | 100° C. or Lower | and 500° C. | Coating Step |
| No. | (° C./s) | (° C.) | (s) | (° C./s) | (° C./s) | Coating Type |
| 57 | 5 | 1000 | 60 | 10 | 6 | |
| 58 | 5 | 1000 | 60 | 10 | 6 | |
| 59 | 5 | 1000 | 60 | 9 | 5 | |
| 60 | 5 | 1000 | 60 | 8 | 5 | |
| 61 | 5 | 1000 | 60 | 8 | 6 | |
| 62 | 5 | 1000 | 60 | 10 | 6 | |
| 63 | 5 | 1000 | 60 | 9 | 5 | |
| 64 | 5 | 1000 | 60 | 9 | 6 | |
| 65 | 5 | 1000 | 60 | 8 | 5 | |
| 66 | 5 | 1000 | 60 | 10 | 6 | |
| 67 | 5 | 1000 | 60 | 10 | 6 | |
| 68 | 5 | 1000 | 60 | 8 | 5 | |
| 69 | 5 | 1000 | 60 | 10 | 5 | |
| 70 | 5 | 1000 | 60 | 9 | 5 | |
| 71 | 5 | 1000 | 60 | 9 | 5 | |
| 72 | 5 | 1000 | 60 | 10 | 6 | |
| 73 | 5 | 1000 | 60 | 10 | 6 | |
| 74 | 2 | 1000 | 60 | 9 | 6 | |
| 75 | 1 | 1000 | 60 | 10 | 6 | |
| 76 | 5 | 952 | 60 | 10 | 5 | |
| 77 | 5 | 1190 | 60 | 9 | 6 | |
| 78 | 5 | 940 | 60 | 10 | 6 | |
| 79 | 5 | 1230 | 60 | 10 | 6 | |
| 80 | 5 | 1000 | 1 | 8 | 6 | |
| 81 | 5 | 1000 | 1200 | 9 | 6 | |
| 82 | 5 | 1000 | 0 | 10 | 6 | |
| 83 | 5 | 1000 | 1250 | 8 | 5 | |
| 84 | 5 | 1000 | 15 | 14 | 5 | |

TABLE 2-8

| | Manufacturing Method | | | | | |
|---|---|---|---|---|---|---|
| | Preliminary Heat Treatment Step | | | | | |
| | | | | Average | Average | |
| | | | | Cooling Rate | Cooling | |
| | | Preliminary | | from Preliminary | Rate | |
| | Average | Heat | | Heat Treatment | Between | |
| | Heating | Treatment | Holding | Temperature to | 700° C. | |
| Test | rate | Temperature | Time | 100° C. or Lower | and 500° C. | Coating Step |
| No. | (° C./s) | (° C.) | (s) | (° C./s) | (° C./s) | Coating Type |
| 85 | 5 | 1000 | 60 | 20 | 5 | |
| 86 | 5 | 1000 | 60 | 10 | 9 | |
| 87 | 5 | 1000 | 60 | 10 | 12 | |
| 88 | 5 | 1000 | 60 | 9 | 6 | |
| 89 | 5 | 1000 | 60 | 9 | 5 | |
| 90 | 5 | 1000 | 60 | 8 | 6 | |
| 91 | 5 | 1000 | 60 | 9 | 5 | |
| 92 | 5 | 1000 | 60 | 9 | 6 | |
| 93 | 5 | 1000 | 60 | 9 | 5 | |
| 94 | 5 | 1000 | 60 | 8 | 6 | |
| 95 | 5 | 1000 | 60 | 9 | 6 | |
| 96 | 5 | 1000 | 60 | 9 | 6 | |
| 97 | 5 | 1000 | 60 | 10 | 6 | |
| 98 | 5 | 1000 | 60 | 10 | 5 | |
| 99 | 5 | 1000 | 60 | 9 | 5 | |
| 100 | 5 | 1000 | 60 | 9 | 5 | |
| 101 | 5 | 1000 | 60 | 9 | 5 | |
| 102 | 5 | 1000 | 60 | 8 | 5 | |
| 103 | 5 | 1000 | 60 | 8 | 6 | |
| 104 | 5 | 1000 | 60 | 8 | 7 | |
| 105 | 5 | 1000 | 60 | 9 | 5 | |
| 106 | 5 | 1000 | 60 | 9 | 5 | |
| 107 | 5 | 1000 | 60 | 9 | 5 | |
| 108 | 45 | 1000 | 60 | 10 | 6 | |
| 109 | 5 | 980 | 95 | 10 | 5 | |
| 110 | 5 | 1000 | 60 | 9 | 5 | Zn-based |
| | | | | | | Hot-dip |
| | | | | | | Coating |
| 111 | 5 | 1000 | 60 | 10 | 5 | |
| 112 | 5 | 1000 | 60 | 10 | 5 | |
| 113 | 5 | 1000 | 60 | 10 | 5 | |

TABLE 2-9

| | Manufacturing Method | | | | |
|---|---|---|---|---|---|
| | Hot Stamping Step | | | | |
| | | Hot- | | | Average |
| | | Stamping | | Forming | Cooling |
| | Average Heating | Heating | | Start | Rate to |
| Test | rate | Temperature | Holding | Temperature | 250° C. |
| No. | (° C./s) | (° C.) | Time(s) | (° C.) | (° C./s) |
| 1 | 5 | 900 | 60 | 700 | 90 |
| 2 | 5 | 920 | 60 | 715 | 115 |
| 3 | 5 | 900 | 60 | 705 | 120 |
| 4 | 5 | 900 | 60 | 703 | 110 |
| 5 | 5 | 900 | 60 | 707 | 125 |
| 6 | 5 | 918 | 59 | 720 | 116 |
| 7 | 6 | 900 | 58 | 725 | 120 |
| 8 | 8 | 960 | 55 | 780 | 95 |
| 9 | 5 | 920 | 60 | 750 | 120 |
| 10 | 7 | 950 | 60 | 790 | 90 |
| 11 | 5 | 900 | 60 | 720 | 120 |
| 12 | 5 | 900 | 60 | 725 | 105 |
| 13 | 6 | 920 | 60 | 790 | 120 |
| 14 | 6 | 920 | 60 | 795 | 125 |
| 15 | 5 | 900 | 30 | 700 | 100 |
| 16 | 5 | 900 | 30 | 700 | 100 |
| 17 | 5 | 900 | 60 | 740 | 110 |
| 18 | 5 | 900 | 60 | 745 | 110 |
| 19 | 5 | 900 | 60 | 750 | 100 |
| 20 | 5 | 900 | 60 | 753 | 105 |
| 21 | 5 | 900 | 60 | 754 | 110 |
| 22 | 5 | 900 | 60 | 755 | 111 |
| 23 | 5 | 900 | 60 | 755 | 112 |
| 24 | 5 | 900 | 60 | 746 | 110 |
| 25 | 5 | 900 | 60 | 750 | 113 |
| 26 | 5 | 900 | 60 | 742 | 110 |
| 27 | 5 | 900 | 60 | 743 | 105 |
| 28 | 5 | 900 | 60 | 744 | 111 |

TABLE 2-10

| | Manufacturing Method | | | | |
|---|---|---|---|---|---|
| | Hot Stamping Step | | | | |
| | | Hot- | | | Average |
| | | Stamping | | Forming | Cooling |
| | Average Heating | Heating | | Start | Rate to |
| Test | rate | Temperature | Holding | Temperature | 250° C. |
| No. | (° C./s) | (° C.) | Time(s) | (° C.) | (° C./s) |
| 29 | 5 | 900 | 60 | 700 | 90 |
| 30 | 5 | 900 | 60 | 740 | 107 |
| 31 | 5 | 890 | 60 | 751 | 120 |
| 32 | 5 | 900 | 60 | 740 | 106 |
| 33 | 5 | 900 | 60 | 740 | 105 |
| 34 | 5 | 890 | 60 | 750 | 105 |
| 35 | 5 | 900 | 60 | 740 | 108 |
| 36 | 5 | 900 | 60 | 742 | 105 |
| 37 | 5 | 900 | 60 | 743 | 104 |
| 38 | 5 | 900 | 60 | 745 | 105 |
| 39 | 5 | 900 | 60 | 740 | 108 |
| 40 | 5 | 900 | 60 | 740 | 110 |
| 41 | 5 | 900 | 60 | 760 | 100 |
| 42 | 5 | 900 | 60 | 755 | 100 |
| 43 | 5 | 900 | 60 | 754 | 109 |
| 44 | 5 | 900 | 60 | 755 | 103 |
| 45 | 5 | 900 | 60 | 765 | 109 |
| 46 | 6 | 920 | 60 | 761 | 109 |
| 47 | 5 | 900 | 60 | 755 | 108 |
| 48 | 5 | 900 | 60 | 754 | 101 |
| 49 | 5 | 900 | 60 | 768 | 102 |
| 50 | 5 | 900 | 60 | 757 | 109 |
| 51 | 5 | 900 | 60 | 766 | 105 |
| 52 | 5 | 900 | 60 | 762 | 106 |
| 53 | 5 | 900 | 60 | 757 | 104 |
| 54 | 5 | 900 | 60 | 759 | 107 |
| 55 | 5 | 900 | 60 | 753 | 107 |
| 56 | 5 | 900 | 60 | 757 | 108 |

TABLE 2-11

| | Manufacturing Method | | | | |
|---|---|---|---|---|---|
| | Hot Stamping Step | | | | |
| | | Hot- | | | Average |
| | | Stamping | | Forming | Cooling |
| | Average Heating | Heating | | Start | Rate to |
| Test | rate | Temperature | Holding | Temperature | 250° C. |
| No. | (° C./s) | (° C.) | Time(s) | (° C.) | (° C./s) |
| 57 | 5 | 900 | 60 | 759 | 101 |
| 58 | 5 | 900 | 60 | 754 | 100 |
| 59 | 5 | 900 | 60 | 751 | 100 |
| 60 | 5 | 900 | 60 | 763 | 103 |
| 61 | 5 | 900 | 60 | 752 | 105 |
| 62 | 5 | 900 | 60 | 764 | 104 |
| 63 | 5 | 900 | 60 | 750 | 102 |
| 64 | 5 | 900 | 60 | 756 | 105 |
| 65 | 5 | 900 | 60 | 751 | 102 |
| 66 | 5 | 900 | 60 | 764 | 100 |
| 67 | 5 | 900 | 60 | 752 | 101 |
| 68 | 5 | 900 | 60 | 762 | 102 |
| 69 | 5 | 900 | 60 | 754 | 101 |
| 70 | 5 | 900 | 60 | 756 | 101 |
| 71 | 5 | 900 | 60 | 752 | 105 |
| 72 | 5 | 900 | 60 | 770 | 100 |
| 73 | 5 | 900 | 60 | 768 | 100 |
| 74 | 5 | 900 | 60 | 756 | 104 |
| 75 | 5 | 900 | 60 | 752 | 105 |
| 76 | 5 | 900 | 60 | 753 | 100 |
| 77 | 5 | 900 | 60 | 762 | 102 |
| 78 | 5 | 900 | 60 | 755 | 101 |
| 79 | 5 | 900 | 60 | 752 | 102 |
| 80 | 5 | 900 | 60 | 762 | 103 |
| 81 | 5 | 900 | 60 | 757 | 104 |
| 82 | 5 | 900 | 60 | 759 | 103 |
| 83 | 5 | 900 | 60 | 758 | 101 |
| 84 | 5 | 900 | 60 | 753 | 103 |

TABLE 2-12

| | Manufacturing Method | | | | |
|---|---|---|---|---|---|
| | Hot Stamping Step | | | | |
| | | Hot- | | | Average |
| | | Stamping | | Forming | Cooling |
| | Average Heating | Heating | | Start | Rate to |
| Test | rate | Temperature | Holding | Temperature | 250° C. |
| No. | (° C./s) | (° C.) | Time(s) | (° C.) | (° C./s) |
| 85 | 5 | 900 | 60 | 759 | 102 |
| 86 | 5 | 900 | 60 | 751 | 102 |
| 87 | 5 | 900 | 60 | 757 | 101 |
| 88 | 2 | 900 | 60 | 756 | 102 |
| 89 | 49 | 900 | 60 | 750 | 105 |
| 90 | 0.5 | 900 | 60 | 753 | 103 |
| 91 | 60 | 900 | 60 | 765 | 103 |
| 92 | 5 | 840 | 60 | 760 | 103 |
| 93 | 5 | 1090 | 60 | 759 | 101 |
| 94 | 5 | 800 | 60 | 753 | 100 |
| 95 | 5 | 1150 | 60 | 751 | 101 |
| 96 | 5 | 900 | 10 | 765 | 104 |
| 97 | 5 | 900 | 600 | 764 | 100 |
| 98 | 5 | 900 | 5 | 764 | 100 |
| 99 | 5 | 900 | 650 | 756 | 100 |
| 100 | 5 | 900 | 60 | 660 | 102 |
| 101 | 5 | 900 | 60 | 600 | 105 |
| 102 | 5 | 900 | 60 | 759 | 20 |
| 103 | 5 | 900 | 60 | 759 | 5 |
| 104 | 5 | 900 | 60 | 750 | 100 |
| 105 | 40 | 860 | 20 | 750 | 100 |
| 106 | 20 | 860 | 20 | 750 | 100 |
| 107 | 5 | 900 | 60 | 760 | 105 |
| 108 | 5 | 900 | 60 | 758 | 100 |
| 109 | 5 | 900 | 60 | 700 | 90 |
| 110 | 5 | 900 | 60 | 755 | 102 |
| 111 | 5 | 900 | 60 | 750 | 115 |
| 112 | 5 | 900 | 60 | 756 | 116 |
| 113 | 5 | 900 | 60 | 755 | 100 |

Regarding the obtained hot-stamping formed body, the microstructure at a ¼-depth position and the microstructure of a surface layer portion were observed in the above-described manner, and area ratios of the microstructures were obtained. Although not shown in the tables, except for ferrite in the surface layer portion, more than 5.0% of martensite and/or bainite, and less than 5.0% of retained austenite and/or pearlite were included in total.

In addition, in the microstructure at the ¼-depth position, the number density of an iron-based carbide present in martensite and having a circle equivalent diameter of more than 0.5 μm and the average distance between the iron-based carbide and another iron-based carbide nearest thereto having a circle equivalent diameter of more than 0.5 μm were obtained.

In addition, a decarburization index and a decarburized depth were obtained.

The results are shown in Tables 3-1 to 3-4. In the examples in which Zn-based hot-dip coating or Al-based hot-dip coating was performed, a coating primarily containing an Fe—Zn-based alloy or a coating primarily containing an Fe—Al-based alloy was formed with a thickness of 30 μm.

TABLE 3-1

| | Hot-Stamping Formed Body | | | | | | | | | | | |
|---|---|---|---|---|---|---|---|---|---|---|---|---|
| | | Microstructure | | | | | | | | | | |
| | | | ¼-Depth Position | | | | | | | | | |
| | | | | | | Number | | | | | | |
| | | | | | | Density of | | | | | | |
| | | | | | | Iron-Based | Average | | | | | |
| | | | | | | Carbide | Distance | | | | | |
| | | | | | | Present In | Between | | | | | |
| | | | | | | Martensite | Iron-Based | | | | | |
| | | Surface | | | | and Having | Carbide | | | | | |
| | Sheet | Layer | | | | Circle | and Another | | | | | |
| | Thickness | Portion | | Retained | | Equivalent | Iron-Based | Prior | | | | |
| | (Flat | Ferrite | Martensite | austenite | Remainder | Diameter | Carbide | Austenite | | Decarbu- | Coating | |
| | Portion | Area | Area | Area | Area | of More | Nearest | Grain | Decarbu- | rization | | Thick- |
| Test | Thickness) | Ratio | Ratio | Ratio | Ratio | Than 0.5 μm | Thereto | Size | rization | Depth | | ness |
| No. | (mm) | (%) | (%) | (%) | (%) | (particles/μm²) | (μm) | (μm) | Index | (μm) | Type | (μm) |
| 1 | 1.60 | 0.5 | 99.0 | 0.3 | 0.7 | 0.008 | 9.0 | 10.5 | 0.050 | 15 | Fe-Zn | 30 |
| 2 | 1.60 | 0.8 | 98.0 | 0.6 | 1.4 | 0.012 | 7.0 | 12.6 | 0.139 | 107 | | |
| 3 | 1.60 | 6.0 | 97.0 | 0.8 | 2.2 | 0.025 | 4.5 | 9.8 | 0.200 | 140 | | |
| 4 | 1.60 | 0.6 | 89.0 | 0.5 | 10.5 | 0.006 | 10.0 | 10.9 | 0.050 | 20 | | |
| 5 | 1.60 | 0.3 | 99.0 | 0.3 | 0.7 | 0.060 | 2.8 | 10.0 | 0.160 | 125 | | |
| 6 | 1.60 | 0.1 | 98.0 | 0.3 | 1.7 | 0.016 | 6.8 | 11.3 | 0.070 | 20 | | |
| 7 | 1.60 | 1.5 | 98.0 | 1.0 | 1.0 | 0.011 | 8.4 | 10.6 | 0.171 | 130 | | |
| 8 | 1.60 | 2.0 | 95.0 | 3.5 | 1.5 | 0.007 | 12.0 | 13.0 | 0.170 | 130 | | |
| 9 | 1.60 | 0.1 | 97.5 | 0.1 | 2.4 | 0.060 | 2.9 | 11.5 | 0.060 | 18 | | |
| 10 | 1.60 | 2.3 | 94.0 | 6.0 | 0.0 | 0.006 | 16.0 | 12.6 | 0.168 | 128 | | |
| 11 | 1.60 | 2.5 | 97.5 | 0.3 | 2.2 | 0.005 | 15.0 | 12.4 | 0.140 | 110 | Fe-Al | 30 |
| 12 | 1.60 | 0.0 | 100.0 | 0.0 | 0.0 | 0.043 | 3.7 | 9.6 | 0.040 | 12 | | |
| 13 | 1.60 | 0.0 | 100.0 | 0.0 | 0.0 | 0.044 | 3.2 | 9.4 | 0.049 | 15 | | |
| 14 | 1.60 | 0.0 | 100.0 | 0.0 | 0.0 | 0.068 | 2.4 | 9.0 | 0.049 | 15 | | |
| 15 | 1.60 | 1.9 | 90.0 | 0.3 | 9.7 | 0.018 | 6.7 | 10.8 | 0.150 | 120 | | |
| 16 | 1.60 | 1.8 | 90.0 | 0.3 | 9.7 | 0.019 | 6.6 | 10.5 | 0.150 | 119 | | |
| 17 | 1.60 | 2.0 | 99.0 | 0.1 | 0.9 | 0.014 | 8.2 | 11.5 | 0.020 | 10 | | |
| 18 | 1.60 | 2.0 | 98.0 | 0.0 | 2.0 | 0.012 | 8.0 | 11.1 | 0.020 | 10 | | |
| 19 | 1.60 | 1.0 | 99.0 | 0.1 | 0.9 | 0.016 | 6.5 | 10.1 | 0.020 | 10 | | |
| 20 | 1.60 | 1.0 | 99.0 | 0.1 | 0.9 | 0.016 | 6.7 | 9.9 | 0.020 | 10 | | |
| 21 | 1.60 | 0.0 | 100.0 | 0.0 | 0.0 | 0.012 | 8.1 | 10.0 | 0.140 | 110 | | |
| 22 | 1.60 | 0.5 | 98.0 | 0.2 | 1.8 | 0.014 | 8.3 | 9.8 | 0.139 | 108 | Fe-Zn | 30 |
| 23 | 1.60 | 0.9 | 96.0 | 1.0 | 3.0 | 0.015 | 7.8 | 10.3 | 0.149 | 119 | | |
| 24 | 1.60 | 0.0 | 100.0 | 0.0 | 0.0 | 0.014 | 8.0 | 10.2 | 0.140 | 109 | | |
| 25 | 1.60 | 1.0 | 93.0 | 0.8 | 6.2 | 0.016 | 6.8 | 10.4 | 0.150 | 120 | | |
| 26 | 1.60 | 2.0 | 88.0 | 0.2 | 11.8 | 0.031 | 4.1 | 10.3 | 0.030 | 12 | | |
| 27 | 1.60 | 0.0 | 99.0 | 0.1 | 0.9 | 0.012 | 8.5 | 9.8 | 0.138 | 103 | | |
| 28 | 1.60 | 0.2 | 100.0 | 0.0 | 0.0 | 0.012 | 6.8 | 11.6 | 0.138 | 102 | | |

TABLE 3-2

| | Hot-Stamping Formed Body | | | | | | | | | | | |
|---|---|---|---|---|---|---|---|---|---|---|---|---|
| | | Microstructure | | | | | | | | | | |
| | | | ¼-Depth Position | | | | | | | | | |
| | | | | | | Number | | | | | | |
| | | | | | | Density of | | | | | | |
| | | | | | | Iron-Based | Average | | | | | |
| | | | | | | Carbide | Distance | | | | | |
| | | | | | | Present In | Between | | | | | |
| | | | | | | Martensite | Iron-Based | | | | | |
| | | Surface | | | | and Having | Carbide | | | | | |
| | Sheet | Layer | | | | Circle | and Another | | | | | |
| | Thickness | Portion | | Retained | | Equivalent | Iron-Based | Prior | | | | |
| | (Flat | Ferrite | Martensite | austenite | Remainder | Diameter | Carbide | Austenite | | Decarbu- | | |
| | Portion | Area | Area | Area | Area | of More | Nearest | Grain | Decarbu- | rization | Coating | |
| Test | Thickness) | Ratio | Ratio | Ratio | Ratio | Than 0.5 μm | Thereto | Size | rization | Depth | | Thickness |
| No. | (mm) | (%) | (%) | (%) | (%) | (particles/μm²) | (μm) | (μm) | Index | (μm) | Type | (μm) |
| 29 | 1.60 | 1.0 | 90.0 | 0.1 | 9.9 | 0.010 | 9.0 | 10.6 | 0.050 | 15 | | |
| 30 | 1.60 | 0.0 | 100.0 | 0.0 | 0.0 | 0.019 | 5.5 | 8.1 | 0.030 | 12 | | |
| 31 | 1.60 | 0.0 | 97.0 | 0.1 | 2.9 | 0.006 | 11.0 | 12.1 | 0.010 | 5 | | |
| 32 | 1.60 | 0.2 | 100.0 | 0.0 | 0.0 | 0.012 | 8.3 | 11.8 | 0.140 | 110 | | |
| 33 | 1.60 | 0.0 | 100.0 | 0.0 | 0.0 | 0.014 | 8.3 | 12.0 | 0.140 | 112 | Fe-Al | 30 |
| 34 | 1.60 | 0.3 | 78.0 | 0.1 | 21.9 | 0.008 | 12.3 | 12.1 | 0.010 | 5 | | |
| 35 | 1.60 | 0.0 | 98.0 | 0.3 | 1.7 | 0.019 | 5.3 | 11.7 | 0.170 | 130 | | |
| 36 | 1.60 | 0.3 | 97.0 | 0.0 | 3.0 | 0.014 | 8.4 | 12.6 | 0.151 | 120 | | |
| 37 | 1.60 | 0.2 | 99.0 | 0.1 | 0.9 | 0.018 | 6.0 | 10.3 | 0.157 | 123 | | |
| 38 | 1.60 | 0.3 | 99.0 | 0.2 | 0.8 | 0.017 | 8.2 | 9.5 | 0.148 | 118 | | |
| 39 | 1.60 | 1.0 | 89.0 | 0.1 | 10.9 | 0.014 | 8.1 | 11.0 | 0.030 | 12 | | |
| 40 | 1.60 | 1.0 | 100.0 | 0.0 | 0.0 | 0.016 | 7.1 | 9.3 | 0.030 | 12 | | |
| 41 | 1.60 | 0.6 | 100.0 | 0.0 | 0.0 | 0.008 | 9.8 | 6.4 | 0.150 | 120 | | |
| 42 | 1.60 | 0.8 | 99.0 | 0.1 | 0.9 | 0.028 | 4.3 | 10.8 | 0.156 | 122 | | |
| 43 | 1.60 | 0.5 | 97.0 | 0.2 | 2.8 | 0.018 | 7.0 | 9.8 | 0.157 | 123 | | |
| 44 | 1.60 | 0.0 | 95.3 | 4.7 | 0.0 | 0.020 | 5.4 | 10.2 | 0.160 | 127 | | |
| 45 | 1.60 | 0.2 | 98.0 | 0.1 | 1.9 | 0.024 | 5.1 | 10.2 | 0.155 | 119 | | |
| 46 | 1.60 | 0.3 | 98.0 | 0.3 | 1.7 | 0.015 | 7.9 | 10.1 | 0.155 | 120 | | |
| 47 | 1.60 | 0.1 | 100.0 | 0.0 | 0.0 | 0.019 | 5.6 | 10.2 | 0.156 | 122 | | |
| 48 | 1.60 | 0.2 | 99.0 | 0.3 | 0.7 | 0.015 | 7.8 | 10.1 | 0.150 | 120 | | |
| 49 | 1.60 | 0.2 | 99.0 | 0.1 | 0.9 | 0.026 | 4.7 | 9.8 | 0.155 | 120 | | |
| 50 | 1.60 | 0.2 | 99.0 | 0.3 | 0.7 | 0.016 | 7.6 | 10.0 | 0.150 | 120 | | |
| 51 | 1.60 | 0.3 | 100.0 | 0.0 | 0.0 | 0.026 | 4.9 | 9.9 | 0.155 | 121 | | |
| 52 | 1.60 | 0.2 | 98.0 | 0.3 | 1.7 | 0.020 | 5.4 | 9.8 | 0.156 | 122 | | |
| 53 | 1.60 | 0.2 | 97.0 | 0.3 | 2.7 | 0.023 | 5.3 | 9.9 | 0.154 | 119 | | |
| 54 | 1.60 | 0.1 | 100.0 | 0.0 | 0.0 | 0.028 | 4.4 | 10.1 | 0.153 | 121 | | |
| 55 | 1.60 | 0.1 | 99.0 | 0.1 | 0.9 | 0.027 | 4.5 | 10.2 | 0.150 | 120 | | |
| 56 | 1.60 | 0.2 | 98.0 | 0.1 | 1.9 | 0.025 | 4.9 | 9.8 | 0.151 | 120 | | |

TABLE 3-3

| | Hot-Stamping Formed Body | | | | | | | | | | | |
|---|---|---|---|---|---|---|---|---|---|---|---|---|
| | | Microstructure | | | | | | | | | | |
| | | | ¼-Depth Position | | | | | | | | | |
| | | | | | | Number | | | | | | |
| | | | | | | Density of | | | | | | |
| | | | | | | Iron-Based | Average | | | | | |
| | | | | | | Carbide | Distance | | | | | |
| | | | | | | Present In | Between | | | | | |
| | | | | | | Martensite | Iron-Based | | | | | |
| | | Surface | | | | and Having | Carbide | | | | | |
| | Sheet | Layer | | | | Circle | and Another | | | | | |
| | Thickness | Portion | | Retained | | Equivalent | Iron-Based | Prior | | | | |
| | (Flat | Ferrite | Martensite | austenite | Remainder | Diameter | Carbide | Austenite | | Decarbu- | | |
| | Portion | Area | Area | Area | Area | of More | Nearest | Grain | Decarbu- | rization | Coating | |
| Test | Thickness) | Ratio | Ratio | Ratio | Ratio | Than 0.5 μm | Thereto | Size | rization | Depth | | Thickness |
| No. | (mm) | (%) | (%) | (%) | (%) | (particles/μm²) | (μm) | (μm) | Index | (μm) | Type | (μm) |
| 57 | 1.60 | 0.6 | 99.0 | 0.1 | 0.9 | 0.010 | 9.5 | 7.8 | 0.150 | 120 | | |
| 58 | 1.60 | 0.6 | 100.0 | 0.0 | 0.0 | 0.007 | 11.3 | 8.1 | 0.150 | 120 | | |
| 59 | 1.60 | 1.0 | 100.0 | 0.0 | 0.0 | 0.011 | 9.3 | 7.4 | 0.155 | 121 | | |
| 60 | 1.60 | 1.0 | 100.0 | 0.0 | 0.0 | 0.009 | 8.3 | 7.8 | 0.155 | 121 | | |
| 61 | 1.60 | 0.9 | 100.0 | 0.0 | 0.0 | 0.010 | 9.9 | 6.8 | 0.154 | 121 | | |
| 62 | 1.60 | 0.6 | 100.0 | 0.0 | 0.0 | 0.009 | 10.0 | 6.2 | 0.150 | 120 | | |
| 63 | 1.60 | 0.9 | 100.0 | 0.0 | 0.0 | 0.002 | 16.8 | 6.2 | 0.155 | 121 | | |
| 64 | 1.60 | 0.9 | 99.0 | 0.1 | 0.9 | 0.032 | 3.9 | 6.5 | 0.156 | 121 | | |
| 65 | 3.00 | 0.0 | 100.0 | 0.0 | 0.0 | 0.016 | 7.7 | 11.5 | 0.030 | 13 | | |
| 66 | 1.60 | 1.2 | 100.0 | 0.0 | 0.0 | 0.010 | 8.1 | 6.8 | 0.164 | 127 | | |
| 67 | 0.80 | 1.2 | 100.0 | 0.0 | 0.0 | 0.007 | 11.5 | 6.2 | 0.163 | 126 | | |
| 68 | 1.60 | 0.4 | 100.0 | 0.0 | 0.0 | 0.014 | 7.2 | 6.5 | 0.140 | 111 | | |
| 69 | 1.60 | 5.2 | 100.0 | 0.0 | 0.0 | 0.006 | 13.4 | 6.6 | 0.170 | 130 | | |
| 70 | 1.60 | 0.1 | 100.0 | 0.0 | 0.0 | 0.012 | 8.8 | 6.5 | 0.162 | 125 | | |
| 71 | 1.60 | 15.0 | 100.0 | 0.0 | 0.0 | 0.008 | 11.2 | 6.7 | 0.180 | 135 | | |
| 72 | 1.60 | 0.0 | 100.0 | 0.0 | 0.0 | 0.009 | 9.6 | 6.3 | 0.090 | 40 | | |
| 73 | 1.60 | 4.0 | 100.0 | 0.0 | 0.0 | 0.007 | 9.9 | 6.4 | 0.200 | 145 | | |
| 74 | 1.60 | 1.2 | 100.0 | 0.0 | 0.0 | 0.003 | 15.8 | 14.7 | 0.163 | 126 | | |
| 75 | 1.60 | 1.0 | 100.0 | 0.0 | 0.0 | 0.003 | 16.4 | 20.5 | 0.166 | 127 | | |
| 76 | 1.60 | 1.0 | 99.0 | 0.2 | 0.8 | 0.032 | 3.8 | 6.1 | 0.155 | 120 | | |
| 77 | 1.60 | 0.5 | 100.0 | 0.0 | 0.0 | 0.002 | 19.7 | 16.8 | 0.150 | 119 | | |
| 78 | 1.60 | 0.9 | 99.0 | 0.1 | 0.9 | 0.064 | 2.7 | 6.1 | 0.154 | 120 | | |
| 79 | 1.60 | 2.0 | 100.0 | 0.0 | 0.0 | 0.002 | 22.3 | 20.8 | 0.150 | 119 | | |
| 80 | 1.60 | 0.9 | 99.0 | 0.1 | 0.9 | 0.046 | 3.1 | 6.2 | 0.154 | 119 | | |
| 81 | 1.60 | 0.9 | 100.0 | 0.0 | 0.0 | 0.004 | 15.1 | 15.4 | 0.155 | 120 | | |
| 82 | 1.60 | 0.7 | 99.0 | 0.2 | 0.8 | 0.056 | 2.9 | 6.2 | 0.154 | 120 | | |
| 83 | 1.60 | 0.8 | 100.0 | 0.0 | 0.0 | 0.003 | 19.9 | 20.2 | 0.154 | 120 | | |
| 84 | 1.60 | 0.9 | 100.0 | 0.0 | 0.0 | 0.014 | 5.9 | 6.3 | 0.154 | 120 | | |

TABLE 3-4

| | Hot-Stamping Formed Body | | | | | | | | | | | |
|---|---|---|---|---|---|---|---|---|---|---|---|---|
| | | Microstructure | | | | | | | | | | |
| | | | ¼-Depth Position | | | | | | | | | |
| | | | | | | Number | | | | | | |
| | | | | | | Density of | | | | | | |
| | | | | | | Iron-Based | Average | | | | | |
| | | | | | | Carbide | Distance | | | | | |
| | | | | | | Present In | Between | | | | | |
| | | | | | | Martensite | Iron-Based | | | | | |
| | | Surface | | | | and Having | Carbide | | | | | |
| | Sheet | Layer | | | | Circle | and Another | | | | | |
| | Thickness | Portion | | Retained | | Equivalent | Iron-Based | Prior | | | | |
| | (Flat | Ferrite | Martensite | austenite | Remainder | Diameter | Carbide | Austenite | | Decarbu- | | |
| | Portion | Area | Area | Area | Area | of More | Nearest | Grain | Decarbu- | rization | Coating | |
| Test | Thickness) | Ratio | Ratio | Ratio | Ratio | Than 0.5 μm | Thereto | Size | rization | Depth | | Thickness |
| No. | (mm) | (%) | (%) | (%) | (%) | (particles/μm²) | (μm) | (μm) | Index | (μm) | Type | (μm) |
| 85 | 1.60 | 0.9 | 99.0 | 0.1 | 0.9 | 0.016 | 2.9 | 6.4 | 0.154 | 120 | | |
| 86 | 1.60 | 1.0 | 100.0 | 0.0 | 0.0 | 0.015 | 5.2 | 6.2 | 0.155 | 121 | | |
| 87 | 1.60 | 0.9 | 99.0 | 0.2 | 0.8 | 0.018 | 1.4 | 6.4 | 0.154 | 120 | | |
| 88 | 1.60 | 1.0 | 100.0 | 0.0 | 0.0 | 0.007 | 9.4 | 13.7 | 0.155 | 121 | | |
| 89 | 1.60 | 1.0 | 99.0 | 0.3 | 0.7 | 0.043 | 3.3 | 5.9 | 0.155 | 121 | | |
| 90 | 1.60 | 0.8 | 100.0 | 0.0 | 0.0 | 0.006 | 10.7 | 20.4 | 0.153 | 119 | | |
| 91 | 1.60 | 1.2 | 98.0 | 0.2 | 1.8 | 0.059 | 2.9 | 5.4 | 0.156 | 123 | | |
| 92 | 1.60 | 0.7 | 96.0 | 0.2 | 3.8 | 0.018 | 5.4 | 5.5 | 0.152 | 118 | | |
| 93 | 1.60 | 0.7 | 100.0 | 0.0 | 0.0 | 0.006 | 11.1 | 14.6 | 0.152 | 118 | | |
| 94 | 1.60 | 4.5 | 78.0 | 0.5 | 21.5 | 0.058 | 2.9 | 5.6 | 0.153 | 119 | | |
| 95 | 1.60 | 0.0 | 100.0 | 0.0 | 0.0 | 0.003 | 18.0 | 26.5 | 0.140 | 108 | | |
| 96 | 1.60 | 0.9 | 99.0 | 0.3 | 0.7 | 0.030 | 4.2 | 6.1 | 0.154 | 119 | | |
| 97 | 1.60 | 1.1 | 100.0 | 0.0 | 0.0 | 0.007 | 10.8 | 13.8 | 0.156 | 123 | | |
| 98 | 1.60 | 0.8 | 96.0 | 0.2 | 3.8 | 0.055 | 2.9 | 6.1 | 0.153 | 118 | | |
| 99 | 1.60 | 1.3 | 100.0 | 0.0 | 0.0 | 0.006 | 17.2 | 20.5 | 0.156 | 122 | | |
| 100 | 1.60 | 0.9 | 85.0 | 0.4 | 14.6 | 0.009 | 10.4 | 6.4 | 0.154 | 119 | | |
| 101 | 1.60 | 0.7 | 75.0 | 0.2 | 24.8 | 0.010 | 10.1 | 6.5 | 0.154 | 119 | | |
| 102 | 1.60 | 0.6 | 83.0 | 0.3 | 16.7 | 0.012 | 6.3 | 6.4 | 0.150 | 118 | | |
| 103 | 1.60 | 50.0 | 21.0 | 0.2 | 78.8 | 0.014 | 6.0 | 6.4 | 0.155 | 121 | | |
| 104 | 1.60 | 0.2 | 98.7 | 0.3 | 1.0 | 0.016 | 7.6 | 10.0 | 0.140 | 108 | | |
| 105 | 1.60 | 0.0 | 82.0 | 0.0 | 18.0 | 0.030 | 4.0 | 1.2 | 0.153 | 118 | | |
| 106 | 1.60 | 0.0 | 90.0 | 0.0 | 10.0 | 0.025 | 4.5 | 3.0 | 0.154 | 120 | | |
| 107 | 1.60 | 3.6 | 100.0 | 0.0 | 0.0 | 0.010 | 9.4 | 5.2 | 0.155 | 120 | | |
| 108 | 1.60 | 0.4 | 100.0 | 0.0 | 0.0 | 0.038 | 3.8 | 6.1 | 0.152 | 117 | | |
| 109 | 1.60 | 9.0 | 97.0 | 0.0 | 3.0 | 0.007 | 11.0 | 10.7 | 0.230 | 170 | | |
| 110 | 1.60 | 0.0 | 100.0 | 0.0 | 0.0 | 0.007 | 9.9 | 6.3 | 0.000 | 0 | | |
| 111 | 1.60 | 1.0 | 99.4 | 0.1 | 0.5 | 0.026 | 6.5 | 8.3 | 0.020 | 10 | | |
| 112 | 1.60 | 1.2 | 99.2 | 0.3 | 0.5 | 0.023 | 6.9 | 8.6 | 0.020 | 10 | | |
| 113 | 1.60 | 0.7 | 99.2 | 0.1 | 0.7 | 0.030 | 3.9 | 6.2 | 0.155 | 120 | | |

A sample was collected from a top sheet part of the obtained, hat-shaped hot-stamping formed body, and a tensile strength was measured in the following manner.

In addition, bendability and crack propagation resistance characteristics were evaluated as collision resistance characteristics.

The results are shown in Tables 3-5 to 3-8.

### [Tensile Strength]

From a top sheet part of the hot-stamping formed body, a sub-size sheet-shaped test piece (parallel portion length: 32 mm, parallel portion width: 6.25 mm) according to the ASTM A370: 2022 standard was collected while maintaining the material thickness (in a case where a coating was provided, without excluding the coating) so that a tensile direction was parallel to a rolling direction, and a tensile test according to JIS Z 2241:2022 was performed with a gauge length of 25.0 mm and a crosshead separation rate of 1.0 mm/min at 20° C. to obtain a tensile strength. The tensile strength was calculated as a value obtained by dividing a maximum test force by a cross-sectional area obtained by multiplying the material thickness (in a case where a coating was provided, the material thickness was a thickness excluding the measured coating thickness) by the parallel portion width of 6.25 mm.

In a case where the tensile strength was 1,500 MPa or more, it was determined that the steel sheet had high strength.

### [Bendability]

From a top sheet part of the hot-stamping formed body, a sample having a width of 30 mm (orthogonal-to-rolling direction) and a length of 60 mm (rolling direction) was collected while maintaining the material thickness of the hot-stamping formed body (in a case where a coating was provided, without excluding the coating), and with this sample, a bending test was performed so that the direction of a bending ridge was in the orthogonal-to-rolling direction. The bending test was performed according to VDA238-100:2017 of VDA standard, and a maximum bending angle was obtained.

In a case where the product of the tensile strength and the maximum bending angle was 80,000 (MPa·degree) or more, the bendability was determined to be excellent. In a case where the product of the tensile strength and the maximum bending angle was 90,000 (MPa·degree) or more, the bendability was determined to be excellent, and in a case where the product was 100,000 (MPa·degree) or more, the bendability was determined to be further improved.

### [Crack Propagation Resistance Characteristics]

Crack propagation resistance characteristics were obtained by a test according to JIS Z 2242:2018 and JIS B 7755:2011. Specifically, from a top sheet part of the hot-stamping formed body, a test piece having a size of 10 mm in width and 55 mm in length was collected while maintaining the material thickness of the hot-stamping formed body (in a case where a coating was provided, without excluding the coating) so that a rolling direction was in a length direction of the test piece, and a V-notch (notch angle: 45°, notch root radius: 0.25 mm, notch root width: 8 mm, notch position (center): a position 27.5 mm away from an end portion in the length direction of the test piece) having a depth of 2 mm was provided in the test piece. Then, three test pieces were overlapped, fixed with a screw, and subjected to an instrumented impact test. Here, in a case where the sheet thickness was 2.00 mm or less, three test pieces were overlapped to perform the test, and in a case where the sheet thickness was more than 2.00 mm, one test piece was used without overlap to perform the test.

The instrumented impact test was performed at 20° C., and a time and an impact force from the start to the end of the test were measured. A displacement was calculated from the product of a test speed of the instrumented impact test and the measured time. Since the fracture surface length of the Charpy test piece was 8 mm, the average value of the impact forces measured in the region where the displacement was 8 mm or more was set as a background. After subtracting the background from the impact forces at all the measurement points, an impact force-displacement curve was created. Since the impact force obtained in the instrumented Charpy test included noise due to inherent vibration, smoothing processing was performed by performing 30-point moving average processing.

FIG. 1 shows an example (schematic diagram) of the impact force-displacement curve. In the obtained impact force-displacement curve, an area under the curve from a displacement of 0 mm to a displacement of 8 mm was calculated, and the obtained value was set as total impact energy. Next, an impact force at which a rapid decrease started in the impact force-displacement curve was searched for with the above-described procedure, and a corresponding displacement (displacement at a time when cracks were initiated) was obtained. An area under the curve from the displacement of 0 mm to the displacement at a time when cracks were initiated was calculated and set as crack initiation energy. A value obtained by subtracting the crack initiation energy from the total impact energy was set as crack propagation energy. A ratio of the crack propagation energy to the total impact energy was set as an index of the crack propagation resistance characteristics. In a case where the ratio of the crack propagation energy to the total impact energy (crack propagation energy/total impact energy) was 0.10 or more, the crack propagation resistance characteristics were determined to be excellent. In a case where the ratio of the crack propagation energy to the total impact energy was 0.20 or more, the crack propagation resistance characteristics were determined to be further improved, and in a case where the ratio was 0.30 or more, the crack propagation resistance characteristics were determined to be even further improved.

TABLE 3-5

| | Hot-Stamping Formed Body | | | | |
|---|---|---|---|---|---|
| | Characteristics | | | | |
| | | Bendability | Bendability | Crack Propagation Resistance | |
| | Strength | Maximum | Tensile Strength × | Characteristics | |
| | Tensile | Bending | Maximum | Crack Propagation Energy/(Crack | |
| Test | Strength | Angle | Bending Angle | Initiation Energy + Crack | |
| No. | (MPa) | (degrees) | (MPa·degree) | Propagation Energy) | Remarks |
| 1 | 1541 | 53 | 81673 | 0.30 | Invention Example |
| 2 | 2313 | 57 | 131841 | 0.28 | Invention Example |
| 3 | 2658 | 41 | 108978 | 0.19 | Invention Example |
| 4 | 1472 | 60 | 88320 | 0.30 | Comparative Example |
| 5 | 2704 | 28 | 75712 | 0.07 | Comparative Example |
| 6 | 2365 | 40 | 94600 | 0.25 | Invention Example |
| 7 | 2324 | 57 | 132468 | 0.30 | Invention Example |
| 8 | 2307 | 65 | 149955 | 0.30 | Invention Example |
| 9 | 2360 | 33 | 77880 | 0.08 | Comparative Example |
| 10 | 2340 | 59 | 138060 | 0.09 | Comparative Example |
| 11 | 2305 | 55 | 126775 | 0.36 | Invention Example |
| 12 | 2351 | 38 | 89338 | 0.16 | Invention Example |
| 13 | 2378 | 35 | 83230 | 0.14 | Invention Example |
| 14 | 2444 | 30 | 73320 | 0.06 | Comparative Example |
| 15 | 2300 | 55 | 126500 | 0.12 | Invention Example |
| 16 | 2310 | 56 | 129360 | 0.09 | Comparative Example |
| 17 | 2070 | 40 | 82800 | 0.15 | Invention Example |
| 18 | 2046 | 37 | 75702 | 0.08 | Comparative Example |
| 19 | 2345 | 35 | 82075 | 0.14 | Invention Example |
| 20 | 2347 | 32 | 75104 | 0.09 | Comparative Example |
| 21 | 2335 | 51 | 119085 | 0.23 | Invention Example |
| 22 | 2314 | 51 | 118014 | 0.22 | Invention Example |
| 23 | 2293 | 50 | 114650 | 0.20 | Invention Example |
| 24 | 2324 | 34 | 79016 | 0.09 | Comparative Example |
| 25 | 2289 | 33 | 75537 | 0.09 | Comparative Example |
| 26 | 2278 | 39 | 88842 | 0.14 | Invention Example |
| 27 | 2355 | 55 | 129525 | 0.27 | Invention Example |
| 28 | 2322 | 52 | 120744 | 0.24 | Invention Example |

TABLE 3-6

| | Hot-Stamping Formed Body | | | | |
|---|---|---|---|---|---|
| | Characteristics | | | | |
| | | Bendability | Bendability | Crack Propagation Resistance | |
| | Strength | Maximum | Tensile Strength × | Characteristics | |
| | Tensile | Bending | Maximum | Crack Propagation Energy/(Crack | |
| Test | Strength | Angle | Bending Angle | Initiation Energy + Crack | |
| No. | (MPa) | (degrees) | (MPa·degree) | Propagation Energy) | Remarks |
| No. | 1468 | 58 | 85144 | 0.32 | Comparative Example |
| 30 | 2342 | 32 | 74944 | 0.09 | Comparative Example |
| 31 | 1533 | 55 | 84315 | 0.31 | Invention Example |
| 32 | 2330 | 52 | 121160 | 0.25 | Invention Example |
| 33 | 2345 | 49 | 114905 | 0.20 | Invention Example |
| 34 | 1386 | 55 | 76230 | 0.09 | Comparative Example |
| 35 | 2350 | 34 | 79900 | 0.09 | Comparative Example |
| 36 | 2285 | 60 | 137100 | 0.30 | Invention Example |
| 37 | 2334 | 55 | 128370 | 0.22 | Invention Example |
| 38 | 2355 | 46 | 108330 | 0.16 | Invention Example |
| 39 | 1455 | 55 | 80025 | 0.30 | Comparative Example |
| 40 | 2374 | 33 | 78342 | 0.09 | Comparative Example |
| 41 | 2437 | 54 | 131598 | 0.35 | Invention Example |
| 42 | 2399 | 50 | 119950 | 0.16 | Invention Example |
| 43 | 2405 | 53 | 127465 | 0.21 | Invention Example |
| 44 | 2350 | 50 | 117500 | 0.15 | Invention Example |
| 45 | 2416 | 48 | 115968 | 0.24 | Invention Example |
| 46 | 2442 | 53 | 129426 | 0.25 | Invention Example |
| 47 | 2427 | 52 | 126204 | 0.24 | Invention Example |
| 48 | 2417 | 46 | 111182 | 0.20 | Invention Example |
| 49 | 2414 | 48 | 115872 | 0.22 | Invention Example |
| 50 | 2392 | 50 | 119600 | 0.28 | Invention Example |
| 51 | 2377 | 49 | 116473 | 0.23 | Invention Example |
| 52 | 2410 | 51 | 122910 | 0.24 | Invention Example |
| 53 | 2370 | 50 | 118500 | 0.20 | Invention Example |
| 54 | 2440 | 50 | 122000 | 0.21 | Invention Example |
| 55 | 2391 | 45 | 107595 | 0.19 | Invention Example |
| 56 | 2389 | 46 | 109894 | 0.20 | Invention Example |

TABLE 3-7

| | Hot-Stamping Formed Body | | | | |
|---|---|---|---|---|---|
| | Characteristics | | | | |
| | | Bendability | Bendability | Crack Propagation Resistance | |
| | Strength | Maximum | Tensile Strength × | Characteristics | |
| | Tensile | Bending | Maximum | Crack Propagation Energy/(Crack | |
| Test | Strength | Angle | Bending Angle | Initiation Energy + Crack | |
| No. | (MPa) | (degrees) | (MPa·degree) | Propagation Energy) | Remarks |
| 57 | 2410 | 49 | 118090 | 0.29 | Invention Example |
| 58 | 2405 | 55 | 132275 | 0.35 | Invention Example |
| 59 | 2417 | 52 | 125684 | 0.31 | Invention Example |
| 60 | 2422 | 56 | 135632 | 0.32 | Invention Example |
| 61 | 2440 | 55 | 134200 | 0.32 | Invention Example |
| 62 | 2444 | 54 | 131976 | 0.36 | Invention Example |
| 63 | 2448 | 62 | 151776 | 0.41 | Invention Example |
| 64 | 2411 | 48 | 115728 | 0.24 | Invention Example |
| 65 | 2410 | 37 | 89170 | 0.30 | Invention Example |
| 66 | 2427 | 56 | 135912 | 0.35 | Invention Example |
| 67 | 2389 | 60 | 143340 | 0.37 | Invention Example |
| 68 | 2444 | 50 | 122200 | 0.28 | Invention Example |
| 69 | 2401 | 65 | 156065 | 0.37 | Invention Example |
| 70 | 2425 | 55 | 133375 | 0.35 | Invention Example |
| 71 | 2378 | 65 | 154570 | 0.34 | Invention Example |
| 72 | 2451 | 44 | 107844 | 0.32 | Invention Example |
| 73 | 2388 | 64 | 152832 | 0.34 | Invention Example |
| 74 | 2399 | 54 | 129546 | 0.38 | Invention Example |
| 75 | 2268 | 35 | 79380 | 0.09 | Comparative Example |
| 76 | 2449 | 47 | 115103 | 0.20 | Invention Example |
| 77 | 2351 | 45 | 105795 | 0.15 | Invention Example |
| 78 | 2408 | 33 | 79464 | 0.08 | Comparative Example |
| 79 | 2277 | 35 | 79695 | 0.08 | Comparative Example |
| 80 | 2378 | 39 | 92742 | 0.13 | Invention Example |
| 81 | 2360 | 47 | 110920 | 0.17 | Invention Example |
| 82 | 2371 | 33 | 78243 | 0.07 | Comparative Example |
| 83 | 2277 | 35 | 79695 | 0.08 | Comparative Example |
| 84 | 2431 | 55 | 133705 | 0.25 | Invention Example |

TABLE 3-8

| | Hot-Stamping Formed Body | | | | |
|---|---|---|---|---|---|
| | Characteristics | | | | |
| | | Bendability | Bendability | Crack Propagation Resistance | |
| | Strength | Maximum | Tensile Strength × | Characteristics | |
| | Tensile | Bending | Maximum | Crack Propagation Energy/(Crack | |
| Test | Strength | Angle | Bending Angle | Initiation Energy + Crack | |
| No. | (MPa) | (degrees) | (MPa·degree) | Propagation Energy) | Remarks |
| 85 | 2436 | 50 | 121800 | 0.09 | Comparative Example |
| 86 | 2445 | 53 | 129585 | 0.24 | Invention Example |
| 87 | 2439 | 52 | 126828 | 0.05 | Comparative Example |
| 88 | 2297 | 46 | 105662 | 0.20 | Invention Example |
| 89 | 2391 | 43 | 102813 | 0.12 | Invention Example |
| 90 | 2260 | 35 | 79100 | 0.08 | Comparative Example |
| 91 | 2414 | 33 | 79662 | 0.08 | Comparative Example |
| 92 | 2378 | 50 | 118900 | 0.21 | Invention Example |
| 93 | 2286 | 50 | 114300 | 0.23 | Invention Example |
| 94 | 2201 | 35 | 77035 | 0.07 | Comparative Example |
| 95 | 2230 | 35 | 78050 | 0.07 | Comparative Example |
| 96 | 2390 | 45 | 107550 | 0.21 | Invention Example |
| 97 | 2297 | 45 | 103365 | 0.21 | Invention Example |
| 98 | 2341 | 34 | 79594 | 0.09 | Comparative Example |
| 99 | 2267 | 35 | 79345 | 0.09 | Comparative Example |
| 100 | 2250 | 48 | 108000 | 0.26 | Invention Example |
| 101 | 2189 | 36 | 78804 | 0.08 | Comparative Example |
| 102 | 2357 | 51 | 120207 | 0.21 | Invention Example |
| 103 | 1296 | 59 | 76464 | 0.09 | Comparative Example |
| 104 | 2400 | 33 | 79200 | 0.08 | Comparative Example |
| 105 | 2380 | 53 | 126140 | 0.22 | Invention Example |
| 106 | 2367 | 55 | 130185 | 0.23 | Invention Example |
| 107 | 2453 | 58 | 142274 | 0.38 | Invention Example |
| 108 | 2397 | 47 | 112659 | 0.16 | Invention Example |
| 109 | 1503 | 105 | 157815 | 0.40 | Invention Example |
| 110 | 2502 | 33 | 82566 | 0.12 | Invention Example |
| 111 | 1834 | 44 | 80696 | 0.18 | Invention Example |
| 112 | 2047 | 43 | 88021 | 0.20 | Invention Example |
| 113 | 2406 | 49 | 117894 | 0.15 | Invention Example |

As can be seen from the results in Tables 1-1 to 3-8, in the examples (inventive examples) in which, in the hot-stamping formed bodies having a tensile strength of 1,500 MPa or more, the chemical composition, the area ratios in the microstructure at the ¼-depth position, the number density of the iron-based carbide present in martensite and having an circle equivalent diameter of more than 0.5 μm, the average distance, and the prior austenite grain size were within the ranges of the present invention, excellent collision resistance characteristics were obtained.

In the comparative examples, even in a case where the tensile strength was less than 1,500 MPa or 1,500 MPa or more, one or more of the chemical composition, the area ratios in the microstructure at the ¼-depth position, the number density of the iron-based carbide present in martensite and having an circle equivalent diameter of more than 0.5 μm, the average distance of the iron-based carbide present in martensite and having an circle equivalent diameter of more than 0.5 μm, and the prior austenite grain size was outside the range of the present invention. As a result, it was not possible to obtain sufficient collision resistance characteristics.

### INDUSTRIAL APPLICABILITY

According to the present invention, it is possible to provide a hot-stamping formed body having high strength and excellent collision resistance characteristics. Therefore, the present invention has high industrial applicability.

1. A hot-stamping formed body comprising, as a chemical composition, by mass %:
C: 0.20% to 0.70%;
Si: 0.010% to 2.000%;
Mn: 0% to 2.00%;
P: 0.100% or less;
S: 0.0100% or less;
N: 0.0100% or less;
O: 0.0200% or less;
Al: 0.0010% to 0.5000%;
Mo: 0.0010% to 1.0000%;
B: 0.0005% to 0.0100%;
Ti: 0.010% to 0.100%;
Nb: 0% to 0.100%;
Cr: 0% to 1.00%;
Co: 0% to 3.00%;
Ni: 0% to 3.00%;
Cu: 0% to 1.00%;
V: 0% to 1.000%;
W: 0% to 1.00%;
Ca: 0% to 1.0000%;
Mg: 0% to 1.0000%;
REM: 0% to 1.0000%;
Sb: 0% to 1.000%;
Zr: 0% to 1.000%;
As: 0% to 1.000%;
one or more of Ta, Re, Os, Ir, Tc, Pb, Se, Bi, and Sn: 0% to 1.000% in total; and
a remainder: Fe and impurities,
wherein in a case where a range from a position at ⅛ of a thickness to a position at ⅜ of the thickness in a thickness direction from a surface is set as a ¼-depth position,
a microstructure at the ¼-depth position includes, by area ratio,
martensite: 80.0% or more, and
retained austenite: 0.0% or more and less than 5.0%,
in the microstructure at the ¼-depth position, a number density of an iron-based carbide present in the martensite and having a circle equivalent diameter of more than 0.5 μm is less than 0.050 particles/μm², and an average distance between the iron-based carbide and another iron-based carbide nearest to the iron-based carbide is 3.0 μm or more, and
in the microstructure at the ¼-depth position, a prior austenite grain size is 20.0 μm or less.

2. The hot-stamping formed body according to claim 1,
wherein a decarburization index Dc is 0.085 or more.

3. The hot-stamping formed body according to claim 1,
wherein, when a range from the surface to 50 μm is set as a surface layer portion, a microstructure of the surface layer portion includes, by area ratio,
ferrite: more than 5.0%.

4. The hot-stamping formed body according to claim 1,
wherein the chemical composition includes, by mass %,
C: more than 0.40% and 0.70% or less,
Si: 0.010% to 2.000%,
Mn: 0% to 1.00%,
P: 0.100% or less,
S: 0.0100% or less,
N: 0.0100% or less,
O: 0.0200% or less,
Al: 0.0010% to 0.5000%,
Mo: 0.0010% to 1.0000%,
B: 0.0005% to 0.0100%,
Ti: 0.010% to 0.100%,
Nb: 0% to 0.100%,
Cr: 0% to 1.00%,
Co: 0% to 3.00%,
Ni: 0% to 3.00%,
Cu: 0% to 1.00%,
V: 0% to 1.000%,
W: 0% to 1.00%,
Ca: 0% to 1.0000%,
Mg: 0% to 1.0000%,
REM: 0% to 1.0000%,
Sb: 0% to 1.000%,
Zr: 0% to 1.000%,
As: 0% to 1.000%,
one or more of Ta, Re, Os, Ir, Tc, Pb, Se, Bi, and Sn: 0% to 1.000% in total, and
a remainder: Fe and impurities.

5. The hot-stamping formed body according to claim 1,
wherein a coating is provided on the surface.

6. The hot-stamping formed body according to claim 5,
wherein the coating primarily contains an Fe—Al-based alloy.

7. The hot-stamping formed body according to claim 5,
wherein the coating primarily contains an Fe—Zn-based alloy.

8. The hot-stamping formed body according to claim 2,
wherein, when a range from the surface to 50 μm is set as a surface layer portion, a microstructure of the surface layer portion includes, by area ratio,
ferrite: more than 5.0%.

9. The hot-stamping formed body according to claim 2,
wherein the chemical composition includes, by mass %,
C: more than 0.40% and 0.70% or less,
Si: 0.010% to 2.000%,
Mn: 0% to 1.00%,
P: 0.100% or less,
S: 0.0100% or less,
N: 0.0100% or less,
O: 0.0200% or less,
Al: 0.0010% to 0.5000%,
Mo: 0.0010% to 1.0000%,
B: 0.0005% to 0.0100%,
Ti: 0.010% to 0.100%,
Nb: 0% to 0.100%,
Cr: 0% to 1.00%,
Co: 0% to 3.00%,
Ni: 0% to 3.00%,
Cu: 0% to 1.00%,
V: 0% to 1.000%,
W: 0% to 1.00%,
Ca: 0% to 1.0000%,
Mg: 0% to 1.0000%,
REM: 0% to 1.0000%,
Sb: 0% to 1.000%,
Zr: 0% to 1.000%,
As: 0% to 1.000%,
one or more of Ta, Re, Os, Ir, Tc, Pb, Se, Bi, and Sn: 0% to 1.000% in total, and
a remainder: Fe and impurities.

10. The hot-stamping formed body according to claim 2,
wherein a coating is provided on the surface.

11. The hot-stamping formed body according to claim 10,
wherein the coating primarily contains an Fe—Al-based alloy.

12. The hot-stamping formed body according to claim 10,
wherein the coating primarily contains an Fe—Zn-based alloy.
